(19) United States
(12) Patent Application Publication
(10) Pub. No.: US 2010/0108640 A1
(43) Pub. Date: May 6, 2010

(54) DRAWING METHOD, STAMPER MANUFACTURING METHOD, INFORMATION RECORDING MEDIUM MANUFACTURING METHOD, AND DRAWING APPARATUS

(75) Inventors: Katsuyuki NAKADA, Tokyo (JP); Mitsuru TAKAI, Tokyo (JP); Kazuhiro HATTORI, Tokyo (JP)

Correspondence Address: GREENBLUM & BERNSTEIN, P.L.C., 1950 ROLAND CLARKE PLACE, RESTON, VA, 20191, US

(73) Assignee: TDK CORPORATION, Tokyo (JP)

(21) Appl. No.: 12/611,148

(22) Filed: Nov. 3, 2009

(30) Foreign Application Priority Data
Nov. 5, 2008 (JP) 2008-284148
Dec. 15, 2008 (JP) 2008-317791
Sep. 15, 2009 (JP) 2009-213355

(51) Int. Cl. B44C 1/22; B29C 59/00; C23F 1/08

(52) U.S. Cl. 216/41; 264/293; 156/345.24

(57) ABSTRACT

A drawing method and a drawing apparatus use a drawing beam to draw a pattern, which will be used when forming a concave/convex pattern, on a resin layer formed on a substrate. When doing so, to prevent insufficient exposure to the drawing beam in certain parts of the pattern that tend to be insufficiently exposed, the number of irradiation of the drawing beam is changed. By doing so, the production of defects in the concave/convex pattern is avoided and the pattern can be made finer.

### BACKGROUND OF THE INVENTION

1. Field of the Invention

The present invention relates to a drawing method and a drawing apparatus that draw a pattern composed of plural exposed regions and plural unexposed regions on a resin layer, a stamper manufacturing method that manufactures a stamper using the drawn pattern, and an information recording medium manufacturing method that manufactures an information recording medium using the manufactured stamper.

2. Description of the Related Art

As one example of this type of drawing method, stamper manufacturing method, and information recording medium manufacturing method, in Japanese Laid-Open Patent Publication No. 2006-268934, the present applicant discloses a drawing method that draws a stamper manufacturing pattern onto a resin layer (a layer of a positive resist) when manufacturing a mother stamper used to manufacture a discrete track-type magnetic disk. In this drawing method disclosed by the present applicant, a positive resist is first applied onto a silicon base plate to form a resin layer (“resist layer”) which is then baked. After this, a two-dimensional pattern of concaves in a concave/convex pattern of the mother stamper to be fabricated is drawn on the resin layer using an electron beam drawing apparatus. More specifically, a silicon base plate on which the resin layer has been formed is set on a rotating stage and is rotated while emitting an electron beam onto the resin layer. When doing so, a control unit of the electron beam drawing apparatus controls the rotating stage to keep the rotational speed of the silicon base plate constant while controlling an electron beam emitting unit to carry out blanking control over emission of the electron beam, and changes an irradiated position of the electron beam in the radial direction whenever the silicon base plate has made one rotation. By doing so, the silicon base plate is divided into plural belt-shaped regions along the direction of rotation of the silicon base plate which are successively irradiated with the electron beam to draw the two-dimensional pattern mentioned above on the resin layer.

Also, when manufacturing the mother stamper described above, by carrying out a developing process on the resin layer after the drawing of the two-dimensional pattern has been completed, parts of the resin layer where a latent image has been formed by exposure to the electron beam (i.e., regions exposed to the electron beam) are removed from the silicon base plate to form concaves, thereby forming a concave/convex pattern with the concaves described above and convexes composed of the remaining resin layer on the silicon base plate. Next, by transferring the formed concave/convex pattern to nickel, a nickel master stamper where the positional relationship between the concaves and convexes is inverted compared to the concave/convex pattern described above is manufactured. After this, by transferring the concave/convex pattern of the master stamper to nickel, a nickel mother stamper where the positional relationship between the concaves and convexes is inverted compared to the concave/convex pattern described above is manufactured. Next, by carrying out an imprinting process using the manufactured mother stamper, a mask pattern used during an etching process is formed on a preform used to manufacture a magnetic disk, and by etching a magnetic layer using the formed mask pattern as a mask, a discrete track-type magnetic disk is manufactured.

### SUMMARY OF THE INVENTION

However, by investigating the drawing method disclosed by the present applicant, the present inventors found the following issues to be solved. When a two-dimensional pattern of the concaves in the concave/convex pattern of the mother stamper is drawn on the resin layer according to the drawing method disclosed by the present applicant (hereinafter referred to as the “conventional drawing method”), by changing the irradiated position in the radial direction of the electron beam on the resin layer by a predetermined pitch whenever the silicon base plate has made one rotation, the silicon base plate is divided into plural belt-shaped regions along the direction of rotation of the silicon base plate and such belt-shaped regions on the resin layer are successively exposed to the electron beam. At present, as the recording density of information recording media (such as magnetic recording media) increases, the concave/convex patterns of stampers used to manufacture information recording media are becoming finer, resulting in the need to draw a much finer two-dimensional pattern when manufacturing a stamper.

On the other hand, the two-dimensional pattern described above includes positions where plural unexposed regions (when the resin layer is a positive resist, regions that will remain on the silicon base plate after the developing process, or when the resin layer is a negative resist, regions that will be removed from the silicon base plate during the developing process) are aligned in both the direction of rotation and the radial direction of the silicon base plate with exposed regions (when the resin layer is a positive resist, regions that will be removed from the silicon base plate during the developing process, or when the resin layer is a negative resist, regions that will remain on the silicon base plate after the developing process) in between. The present inventors found that when a fine two-dimensional pattern has been drawn according to the conventional drawing method, depending on the type of two-dimensional pattern, at positions where plural unexposed regions are aligned as described above in both the direction of rotation and the radial direction with exposed regions in between, the amount of exposure to the electron beam is less in exposed regions that contact unexposed regions in the direction of rotation than in exposed regions that contact unexposed regions in the direction of rotation, and due to this, there are cases where the amount of exposure is insufficient in exposed regions that contact unexposed regions in the direction of rotation.

More specifically, when for example exposure patterns Pax, Pbx (see FIG. 33) are drawn according to the conventional drawing method as the two-dimensional pattern described above on a layer of a positive resist as the resin layer, as shown in FIGS. 34 and 35, the electron beam is emitted with the same irradiation pitch P1 on both exposed regions Aa1x (regions that have been diagonally shaded with broken lines from top left in the drawings) that contact an unexposed region Abx (as one example, the unexposed region Abx in the upper-center in the drawings) in the radial direction (the left-right direction in the drawings) of the silicon base plate and exposed regions Aa2x (regions that have been diagonally shaded with broken lines from top right in the drawings) that contact the unexposed region Abx in the direction of rotation (the up-down direction in the drawings). Note that in FIGS. 33 to 35, a position that corresponds to a burst pattern out of the exposure patterns Pax, Pbx is shown. Also, the exposed regions Aax in FIGS. 33 to 35 show regions that will be removed during developing due to exposure to the electron beam EB. In addition, in FIGS. 34 and 35, paths that are relatively traced by the beam center of the electron beam emitted onto the resin layer when drawing the exposure patterns Pax, Pbx are shown by the thick lines L.

In this case, in the exposure patterns Pax, Pbx described above, the length L2 (see FIG. 33) along the direction of rotation of the exposed regions Aa2x is shorter than the length L1 (see FIG. 33) along the direction of rotation of the exposed regions Aa1x. This means that when the exposure patterns Pax, Pbx are drawn, during one emission (scan) of the electron beam, the distance (that is, irradiation time) on the resin layer that is exposed when the electron beam is emitted onto the exposed regions Aa2x is shorter than the distance (that is, irradiation time) on the resin layer that is exposed when the electron beam is emitted onto the exposed region Aa1x. Also, with the conventional drawing method, as described above, the electron beam is emitted with the same irradiation pitch P1 onto both the exposed regions Aa1x and Aa2x.

On the other hand, the present inventors found that when the electron beam is emitted with the same irradiation pitch P1 in both the exposed regions Aa1x and Aa2x according to the conventional drawing method, there are cases where the amount of exposure is insufficient in the exposed regions Aa2x described above where the distance (that is, irradiation time) on the resin layer exposed to the electron beam is short. In this case, with the exposure patterns Pax, Pbx where the amount of exposure is insufficient in the exposed regions Aa2x, when the resin layer (in this example, a layer of positive resist) has been subjected to a developing process following the drawing process, the resin layer may remain on the silicon base plate in parts of the exposed regions Aa2x that are regions that should be removed from the silicon base plate, resulting in the production of defects in the concave/convex pattern described above which is used to manufacture a master stamper.

When a mother stamper to be used for an imprinting process has been manufactured using a master stamper manufactured using a concave/convex pattern in which defects have been produced as described above, small convexes may be formed at positions where concaves should be formed. In the worst case scenario, convexes that should be separately formed on the mother stamper may be connected at positions corresponding to the positions described above where the amount of exposure was insufficient. When an imprinting process is carried out using a mother stamper on which defects have been produced as described above, small concaves may be formed at positions where convexes should be formed on the magnetic disk. In the worst case scenario, concaves that should be separately formed may be connected at positions corresponding to the positions described above where the amount of exposure was insufficient. Due to such defects, there is the risk that it will be difficult to correctly read a magnetic signal. In this way, since defects may be produced due to an insufficient amount of exposure in exposed regions that contact unexposed regions in the direction of rotation, such issue with the conventional drawing method should preferably be solved.

At present, as the recording density of information recording media (such as magnetic recording media) increases, to further reduce the track pitch, it is becoming necessary to make the component parts of exposure patterns drawn when manufacturing stampers even smaller in the radial direction. Accordingly, in the exposure pattern Pax and the like described above, it is necessary to make the length L3x (see FIG. 34) along the radial direction of the exposed regions Aax (the exposed regions Aa1x) between unexposed regions Abx that are adjacent in the radial direction and/or the length L4x (see FIG. 34) along the radial direction of the unexposed regions Abx even shorter. The present inventors found that although it is comparatively easy to draw an exposure pattern where the length L4x of the unexposed regions Abx is reduced, there is the risk of insufficient exposure when drawing an exposure pattern so that the length L3x of the exposed regions Aax (the exposed regions Aa1x) is reduced.

More specifically, as shown in FIG. 34, when drawing the exposure pattern Pax described above, the electron beam is emitted onto the resin layer five times with the irradiation pitch P1 to draw one exposed region Aa1x. On the other hand, if the number of times the electron beam is emitted onto the resin layer to draw a single exposed region Aa1x were set at four, for example, to make the length along the radial direction of the exposed region Aa1x shorter than the length L3x without changing the other drawing conditions, although the length along the radial direction of the drawn exposed region Aa1x will be shorter than the length L3x by a distance corresponding to the irradiation pitch P1, there is the risk of the amount of exposure in the exposed region Aa1x being insufficient. With an exposure pattern Pax (not shown) in which the amount of exposure is insufficient in the exposed region Aa1x, when the resin layer is subjected to a developing process following the drawing process, the resin layer may remain on the silicon base plate in part of the exposed region Aa1x which is a region where the resin layer should be removed from the silicon base plate and a defect may therefore be produced in the concave/convex pattern described above that is used to manufacture a master stamper. This issue should be remedied.

The present invention was conceived in view of the issues described above and it is a principal object of the present invention to provide a drawing method and drawing apparatus that are capable of drawing a pattern without causing insufficiencies in exposure, and a stamper manufacturing method and information recording medium manufacturing method that are capable of forming a concave/convex pattern without producing defects. It is a further object of the present invention to provide a drawing method and drawing apparatus that are capable of drawing a pattern where lengths along the radial direction are sufficiently reduced as necessary without causing insufficiencies in exposure, and a stamper manufacturing method and information recording medium manufacturing method that are capable of forming a concave/convex pattern without producing defects even when lengths along the radial direction are sufficiently reduced as necessary.

To achieve the stated objects, a drawing method according to the present invention is operable when rotating a substrate that has a resin layer formed on a surface thereof and emitting a drawing beam onto the resin layer to draw a pattern composed of plural exposed regions and plural unexposed regions on the resin layer, to carry out a process that emits the drawing beam onto the resin layer along a direction of rotation of the substrate multiple times and to change an irradiated position of the drawing beam in a radial direction of the substrate with a predetermined irradiation pitch in at least part of the substrate during the process, wherein when drawing the pattern that includes a position where a predetermined one out of the plural unexposed regions is surrounded by four exposed regions composed of two first exposed regions that contact the predetermined unexposed region in the radial direction and two second exposed regions that contact the predetermined unexposed region in the direction of rotation and where a second length along the direction of rotation of at least one of the two second exposed regions is shorter than a first length along the direction of rotation of at least one of the two first exposed regions, the drawing beam is emitted onto the resin layer so that if a number of times the drawing beam is emitted onto first regions to become the at least one first exposed region is set at N (where N is a natural number that is at least two), a length along the radial direction of the first regions is set at a third length, a number of times the drawing beam is emitted onto second regions to become the at least one second exposed region is set at M (where M is a natural number that is at least two), and a length along the radial direction between a beam center when the drawing beam is emitted onto an innermost periphery in the radial direction of the second regions out of the M times the drawing beam is emitted and a beam center when the drawing beam is emitted onto an outermost periphery in the radial direction of the second regions out of the M times the drawing beam is emitted is set at a fourth length, a value produced by dividing the fourth length by (M−1) is lower than a value produced by dividing the third length by (N+1).

Also, a drawing apparatus according to the present invention comprises: a rotating mechanism that rotates a substrate which has a resin layer formed on a surface thereof; a beam emitting unit that emits a drawing beam onto the resin layer; an irradiated position changing unit that changes an irradiated position of the drawing beam in a radial direction of the substrate; and a control unit operable when drawing a pattern composed of plural exposed regions and plural unexposed regions on the resin layer, to control the rotating mechanism to rotate the substrate, to control the beam emitting unit to carry out a process that emits the drawing beam onto the resin layer along a direction of rotation of the substrate multiple times, and to control the irradiated position changing unit during the process to change the irradiated position with a predetermined irradiation pitch in at least part of the substrate, wherein the control unit is operable when drawing the pattern that includes a position where a predetermined one out of the plural unexposed regions is surrounded by four exposed regions composed of two first exposed regions that contact the predetermined unexposed region in the radial direction and two second exposed regions that contact the predetermined unexposed region in the direction of rotation and where a second length along the direction of rotation of at least one of the two second exposed regions is shorter than a first length along the direction of rotation of at least one of the two first exposed regions, to control the irradiated position changing unit so that if a number of times the drawing beam is emitted onto first regions to become the at least one first exposed region is set at N (where N is a natural number that is at least two), a length along the radial direction of the first regions is set at a third length, a number of times the drawing beam EB is emitted onto second regions to become the at least one second exposed region is set at M (where M is a natural number that is at least two), and a length along the radial direction between a beam center when the drawing beam is emitted onto an innermost periphery in the radial direction of the second regions out of the M times the drawing beam is emitted and a beam center when the drawing beam is emitted onto an outermost periphery in the radial direction of the second regions out of the M times the drawing beam is emitted is set at a fourth length, a value produced by dividing the fourth length by (M−1) is lower than a value produced by dividing the third length by (N+1).

Also, in the drawing method according to the present invention, when drawing the pattern that includes the position where the predetermined unexposed region is surrounded by the four exposed regions and where the second length of the at least one second exposed regions is shorter than the first length of the at least one first exposed regions, the drawing beam may be emitted onto the resin layer so that a first average irradiation pitch of the drawing beam emitted onto the first regions is narrower than a second average irradiation pitch of the drawing beam emitted onto the second regions.

Also, in the drawing apparatus according to the present invention, the control unit may be operable when drawing the pattern that includes the position where the predetermined unexposed region is surrounded by the four exposed regions and where the second length of the at least one second exposed regions is shorter than the first length of the at least one first exposed regions, to control the irradiated position changing unit so that a first average irradiation pitch of the drawing beam emitted onto the first regions is narrower than a second average irradiation pitch of the drawing beam emitted onto the second regions.

Also, in the drawing method according to the present invention, when drawing the pattern that includes the position where the predetermined unexposed region is surrounded by the four exposed regions and where the second length of the at least one second exposed regions is shorter than the first length of the at least one first exposed regions, the drawing beam may be emitted onto the resin layer so that a second average irradiation pitch of the drawing beam emitted onto the second regions is narrower than a first average irradiation pitch of the drawing beam emitted onto the first regions.

Also, in the drawing apparatus according to the present invention, the control unit may be operable when drawing the pattern that includes the position where the predetermined unexposed region is surrounded by the four exposed regions and where the second length of the at least one second exposed regions is shorter than the first length of the at least one first exposed regions, to control the irradiated position changing unit so that a second average irradiation pitch of the drawing beam emitted onto the second regions is narrower than a first average irradiation pitch of the drawing beam emitted onto the first regions.

Here, the expression “exposed regions” in the present specification refers to regions that match regions to be removed from the substrate by a developing process after the drawing of the pattern has been completed in the case where the resin layer has been formed of a positive resist or the like and to regions that match regions that remain on the substrate after a developing process in the case where the resin layer has been formed of a negative resist or the like. Also, the expression “unexposed regions” in the present specification includes not only regions onto which the drawing beam is not emitted but also regions that are slightly irradiated with the drawing beam when the exposed regions are irradiated but which remain in the same state as regions onto which the drawing beam is not emitted after developing. More specifically, when drawing a pattern on a layer of positive resist as the resin layer, this refers to regions that remain on the substrate after developing in the same way as regions onto which the drawing beam is not emitted, and when drawing a pattern on a layer of negative resist as the resin layer, this refers to regions that are removed from the substrate during developing in the same way as regions onto which the drawing beam is not emitted.

Also, the expression “first exposed region” given above refers to an exposed region that is included in a region that is positioned in the radial direction relative to a predetermined one of the unexposed regions and is bordered by a pair of virtual extended lines produced by extending both edges that face each other along the radial direction of the predetermined unexposed region. Here, the expression “first exposed region” includes not only separate exposed regions that are positioned in the radial direction relative to the predetermined unexposed region and have a length along the direction of rotation that is equal to the length along the direction of rotation of the predetermined unexposed region, but also an exposed region in a range within an exposed region that is positioned in the radial direction relative to the predetermined unexposed region but has a longer length along the direction of rotation than the length along the direction of rotation of the predetermined unexposed region, the range being bordered by the pair of virtual extended lines described above (a state where exposed regions are continuous at at least one end in the direction of rotation of a “first exposed region”).

In addition, the expression “second exposed region” given above refers to an exposed region that is included in a region that is positioned in the direction of rotation relative to a predetermined one of the unexposed regions and is bordered by a pair of virtual extended lines produced by extending both edges that face each other along the direction of rotation of the predetermined unexposed region. In this case, the expression “second exposed region” includes not only separate exposed regions that are positioned in the direction of rotation relative to the predetermined unexposed region and have a length along the radial direction that is equal to the length along the radial direction of the predetermined unexposed region, but also an exposed region in a range within an exposed region that is positioned in the direction of rotation relative to the predetermined unexposed region but has a longer length along the radial direction than the length along the radial direction of the predetermined unexposed region, the range being bordered by the pair of virtual extended lines described above (a state where exposed regions are continuous at at least one end in the radial direction of a “second exposed region”).

Also, the expression “number of times the drawing beam is emitted onto a first region” refers to the number of times the beam center of the drawing beam relatively passes a first region (i.e., the number of passes) when drawing a pattern. Similarly, the expression “number of times the drawing beam is emitted onto a second region” refers to the number of times the beam center of the drawing beam relatively passes a second region (i.e., the number of passes) when drawing a pattern. Note that to clarify the present invention, an emission where the beam center of the drawing beam matches one end in the radial direction of a second region is included in the “number of times the drawing beam is emitted onto a second region”.

According to the drawing method and drawing apparatus described above, in the same way as on the first regions, it is possible to sufficiently emit the drawing beam onto the second regions to become the second exposed regions where the amount of exposure tends to be insufficient due to the irradiation distance (irradiation time) of the drawing beam being shorter than in the first regions due to the shorter length along the direction of rotation. By doing so, according to the drawing method and the drawing apparatus, it is possible to avoid a situation where defects are produced in the concave/convex pattern that is formed by a developing process after the pattern has been drawn (defects whereby convexes are formed at positions where concaves should be formed corresponding to the exposed regions or defects whereby concaves are formed at positions where convexes should be formed corresponding to the exposed regions) and thereby form the desired concave/convex pattern with high precision. Here, by emitting the drawing beam onto the resin layer so that the first average irradiation pitch of the drawing beam emitted onto the first regions is narrower than the second average irradiation pitch of the drawing beam emitted onto the second regions, it is possible to sufficiently emit the drawing beam onto the first regions to become the first exposed regions where there is a tendency for the amount of exposure to be insufficient when the length along the radial direction of the component parts of the pattern is shortened, and therefore achieve the effects described above.

Further, in the drawing method according to the present invention, the drawing beam may be emitted onto the resin layer so that the irradiation pitch of the drawing beam in a center in the radial direction of the second regions is narrower than the first average irradiation pitch.

According to the above drawing method, since it is possible to reliably emit the drawing beam sufficiently onto the center in the radial direction of the second exposed regions that is susceptible to insufficient exposure, it is possible to reliably avoid a situation where defects are produced in the concave/convex pattern formed by the developing process.

Also, a stamper manufacturing method according to the present invention comprises: drawing the pattern on the resin layer in accordance with any the drawing methods described above; carrying out a developing process to form concaves in one of the exposed regions and the unexposed regions and thereby form a first concave/convex pattern on the substrate; transferring one of the first concave/convex pattern and a second concave/convex pattern formed using the first concave/convex pattern onto a stamper forming member in accordance with a predetermined procedure to manufacture a stamper.

According to the above stamper manufacturing method, it is possible to avoid a situation where a concave/convex pattern with defects is formed on a stamper and thereby manufacture a stamper on which the desired concave/convex pattern has been formed with high precision. Therefore, according to the above stamper manufacturing method, by manufacturing a magnetic recording medium or the like by forming a concave/convex pattern (mask pattern) by carrying out an imprinting process using the manufactured stamper, it is possible to form a pattern with high precision without defects that may lead to read errors for servo patterns and the like. Here, by manufacturing an information recording medium using a stamper manufactured by emitting the drawing beam onto the resin layer so that when the pattern is drawn, the first average irradiation pitch of the drawing beam emitted onto the first regions is narrower than the second average irradiation pitch of the drawing beam emitted onto the second regions, it is possible to sufficiently reduce the length along the radial direction of the component parts of the servo patterns and the like and thereby raise the recording density.

Also, an information recording medium manufacturing method according to the present invention comprises: carrying out an imprinting process using the stamper manufactured in accordance with the stamper manufacturing method described above to form a mask concave/convex pattern in a mask forming layer on a preform for manufacturing an information recording medium; and carrying out an etching process on the preform using the mask forming layer in which the mask concave/convex pattern has been formed as a mask to manufacture an information recording medium.

According to the above information recording medium manufacturing method, it is possible to manufacture an information recording medium by forming a concave/convex pattern (mask pattern) by carrying out an imprinting process using a stamper on which a concave/convex pattern has been formed with high precision and therefore to manufacture an information recording medium on which a pattern is formed with high precision and without defects that may lead to read errors for servo patterns and the like. Here, by using a stamper manufactured by emitting the drawing beam onto the resin layer so that when the pattern is drawn, the first average irradiation pitch of the drawing beam emitted onto the first regions is narrower than the second average irradiation pitch of the drawing beam emitted onto the second regions, it is possible to sufficiently reduce the length along the radial direction of the component parts of the servo patterns and the like and thereby manufacture an information recording medium capable of high-density recording.

It should be noted that the disclosure of the present invention relates to the contents of Japanese Patent Application 2008-284148 that was filed on 5 Nov. 2008, Japanese Patent Application 2008-317791 that was filed on 15 Dec. 2008, and Japanese Patent Application 2009-213355 that was filed on 15 Sep. 2009, the entire contents of which are herein incorporated by reference.

### BRIEF DESCRIPTION OF THE DRAWINGS

These and other objects and features of the present invention will be explained in more detail below with reference to the attached drawings, wherein:

FIG. 1 is a block diagram of an electron beam drawing apparatus;

FIG. 2 is a cross-sectional view of a magnetic disk;

FIG. 3 is a cross-sectional view of a stamper;

FIG. 4 is a cross-sectional view of a preform and a B mask layer for manufacturing a magnetic disk;

FIG. 5 is a cross-sectional view of a workpiece used to manufacture a stamper;

FIG. 6 is a plan view of an exposure pattern;

FIG. 7 is a diagram useful in explaining the relationship between the exposure pattern (exposed regions and unexposed regions) and thick lines showing paths traced by the beam center of an electron beam;

FIG. 8 is another diagram useful in explaining the relationship between the exposure pattern (exposed regions and unexposed regions) shown in FIG. 7 and thick lines showing paths traced by the beam center of an electron beam;

FIG. 9 is a cross-sectional view of the workpiece in a state where a concave/convex pattern has been formed by a developing process carried out after drawing on the resin layer is complete;

FIG. 10 is a cross-sectional view showing a state where a nickel layer has been formed on the concave/convex pattern of the workpiece;

FIG. 11 is a cross-sectional view showing a state where a stamper has been formed by forming a nickel layer by carrying out an electrocasting process that uses the nickel layer formed on the concave/convex pattern as an electrode;

FIG. 12 is a cross-sectional view of a state where a stamper has been formed by an electrocasting process using a stamper (the laminated body composed of the nickel layers shown in FIG. 11);

FIG. 13 is a cross-sectional view of a state where a stamper has been formed by an injection molding process using the stamper formed as shown in FIG. 12;

FIG. 14 is a cross-sectional view of a state where the convexes of the stamper have been pressed into a B mask layer on a preform;

FIG. 15 is a cross-sectional view of a state where the stamper has been separated from the B mask layer (preform) in the state shown in FIG. 14;

FIG. 16 is a cross-sectional view of the preform in a state where a concave/convex pattern has been formed in an A mask layer by an etching process using the B mask layer (concave/convex pattern) as a mask;

FIG. 17 is a cross-sectional view of the preform in a state where a concave/convex pattern has been formed in a magnetic layer by an etching process using the A mask layer (concave/convex pattern) as a mask;

FIG. 18 is a cross-sectional view of the preform in a state where a layer of an non-magnetic material has been formed on the concave/convex pattern;

FIG. 19 is a cross-sectional view of the preform in a state where the surface has been smoothed by an etching process on the layer of the non-magnetic material;

FIG. 20 is a diagram useful in showing the relationship between another exposure pattern (exposed regions and unexposed regions) and thick lines showing paths traced by the beam center of the electron beam;

FIG. 21 is a diagram useful in showing the relationship between yet another exposure pattern (exposed regions and unexposed regions) and thick lines showing paths traced by the beam center of the electron beam;

FIG. 22 is another diagram useful in showing the relationship between the exposure pattern (exposed regions and unexposed regions) shown in FIG. 21 and thick lines showing paths traced by the beam center of the electron beam;

FIG. 23 is a diagram useful in showing the relationship between yet another exposure pattern (exposed regions and unexposed regions) and thick lines showing paths traced by the beam center of the electron beam;

FIG. 24 is a diagram useful in showing the relationship between yet another exposure pattern (exposed regions and unexposed regions) and thick lines showing paths traced by the beam center of the electron beam;

FIG. 25 is another diagram useful in showing the relationship between the exposure pattern (the exposed regions and unexposed regions) shown in FIG. 24 and thick lines showing paths traced by the beam center of the electron beam;

FIG. 26 is a schematic diagram showing yet another exposure pattern;

FIG. 27 is a schematic diagram showing yet another exposure pattern;

FIG. 28 is a schematic diagram showing yet another exposure pattern;

FIG. 29 is a schematic diagram showing yet another exposure pattern;

FIG. 30 is a schematic diagram showing yet another exposure pattern;

FIG. 31 is a schematic diagram showing yet another exposure pattern;

FIG. 32 is a schematic diagram showing yet another exposure pattern;

FIG. 33 is a plan view of an exposure pattern drawn according to a conventional drawing method;

FIG. 34 is a diagram useful in showing the relationship between the exposure pattern (exposed regions and unexposed regions) shown in FIG. 33 and thick lines showing paths traced by the beam center of the electron beam; and

FIG. 35 is another diagram useful in showing the relationship between the exposure pattern (exposed regions and unexposed regions) shown in FIG. 33 and thick lines showing paths traced by the beam center of the electron beam.

### DESCRIPTION OF THE PREFERRED EMBODIMENTS

Preferred embodiments of a drawing method, a stamper manufacturing method, an information recording medium manufacturing method, and a drawing apparatus will now be described with reference to the attached drawings.

First, the construction of an electron beam drawing apparatus 1 that draws a pattern will be described with reference to the drawings.

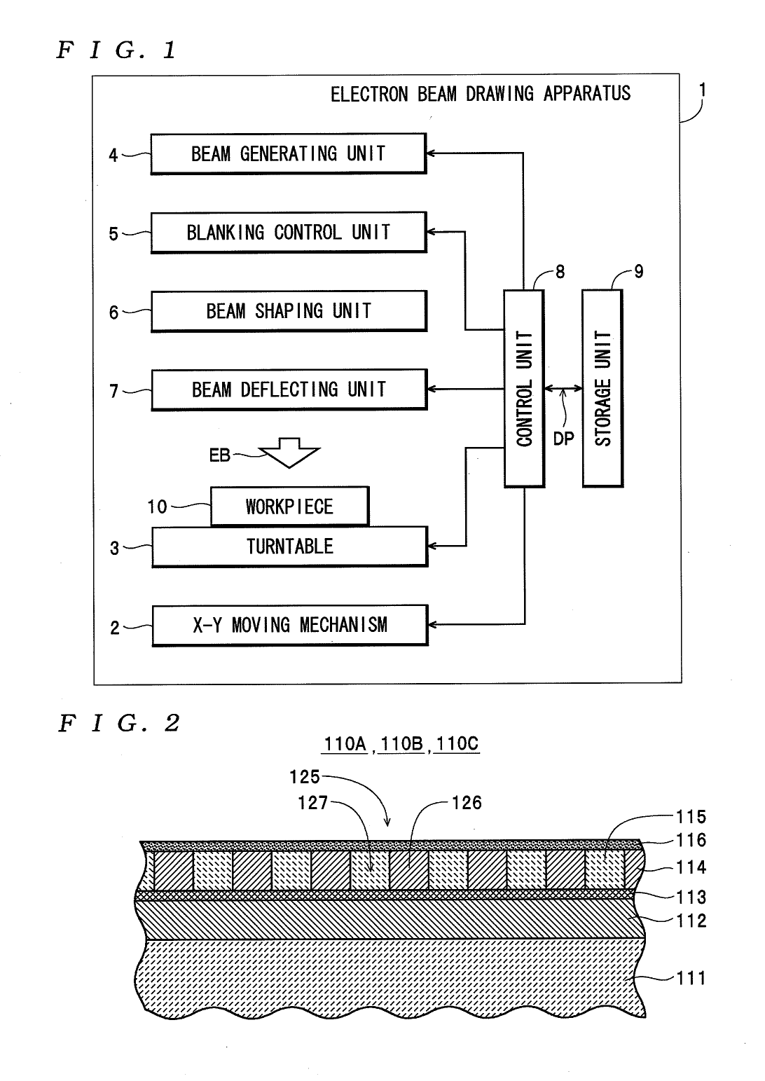

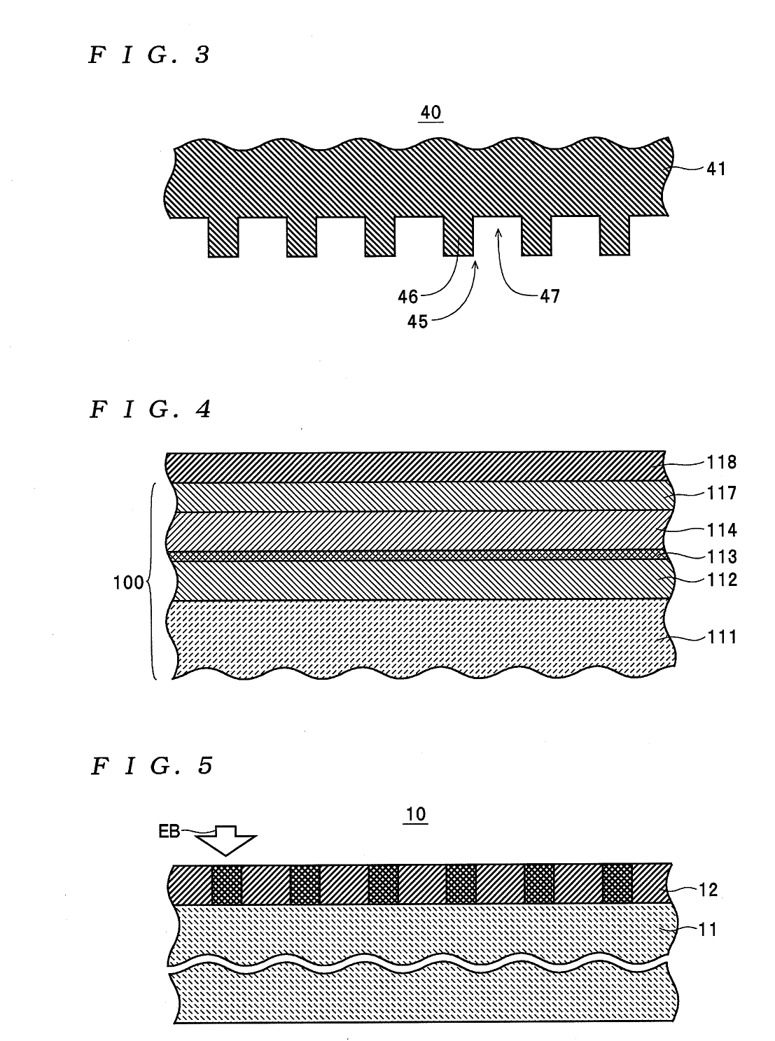

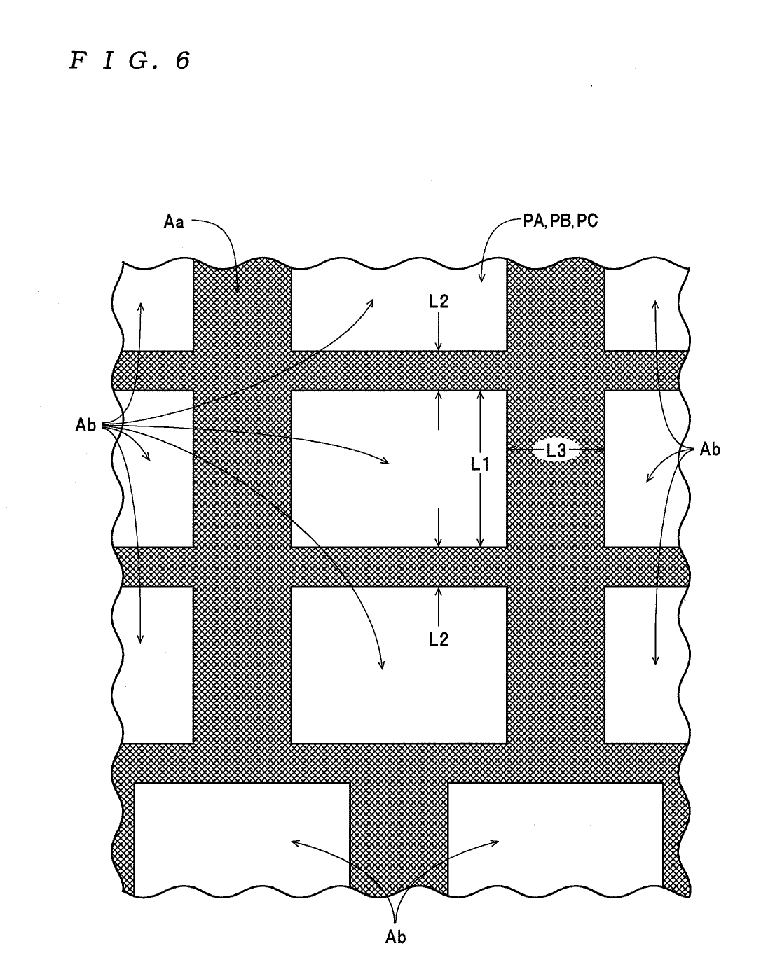

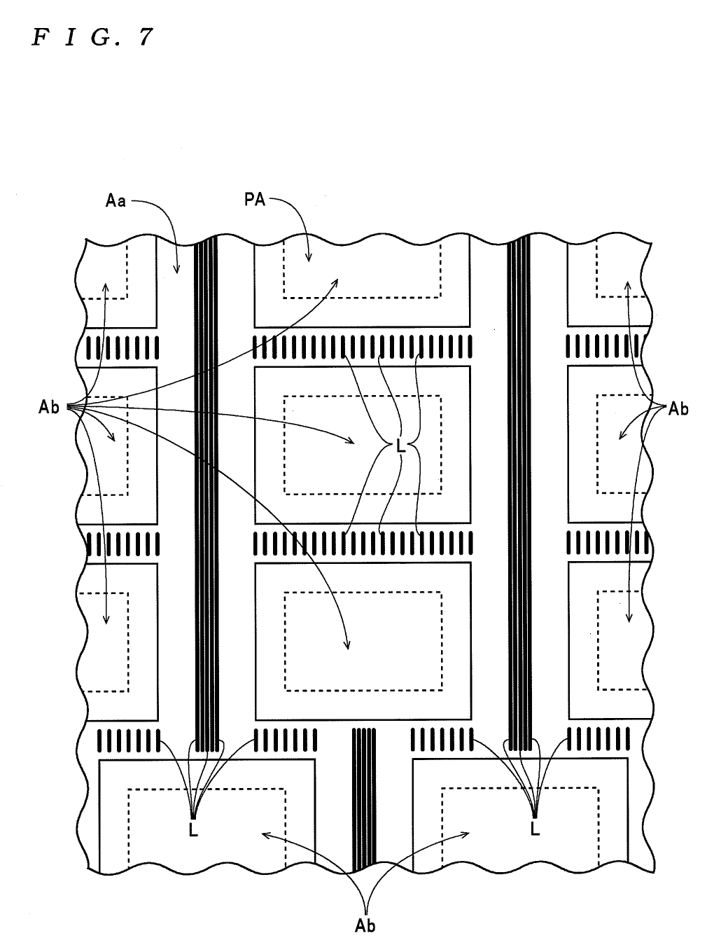

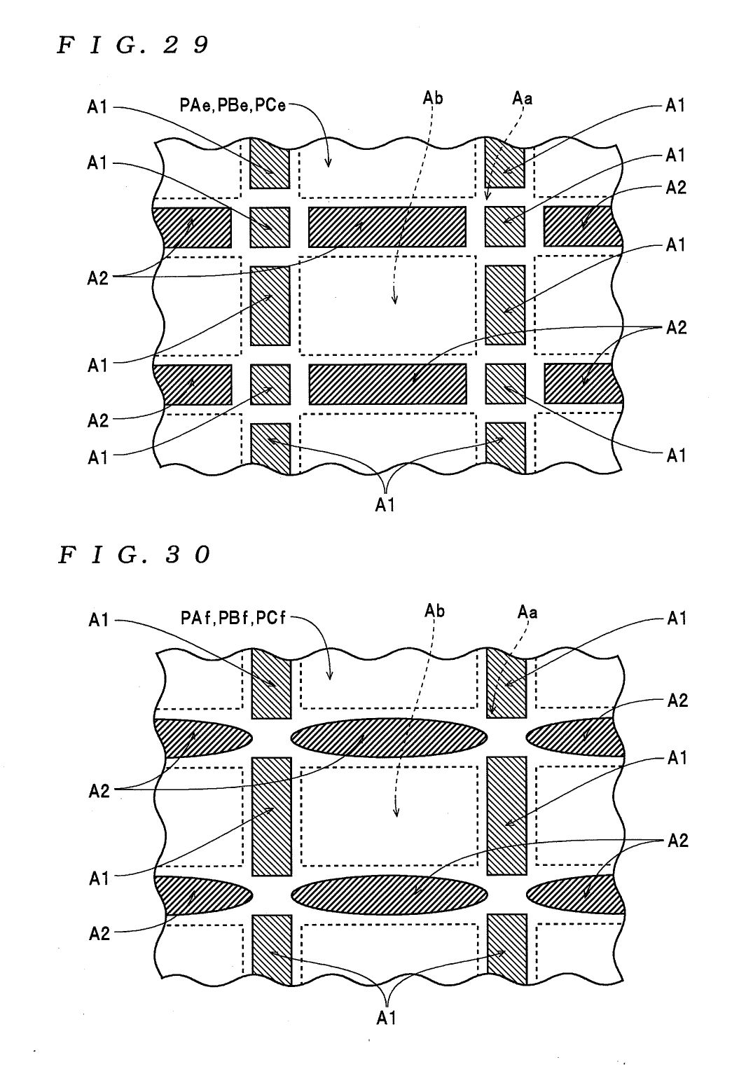

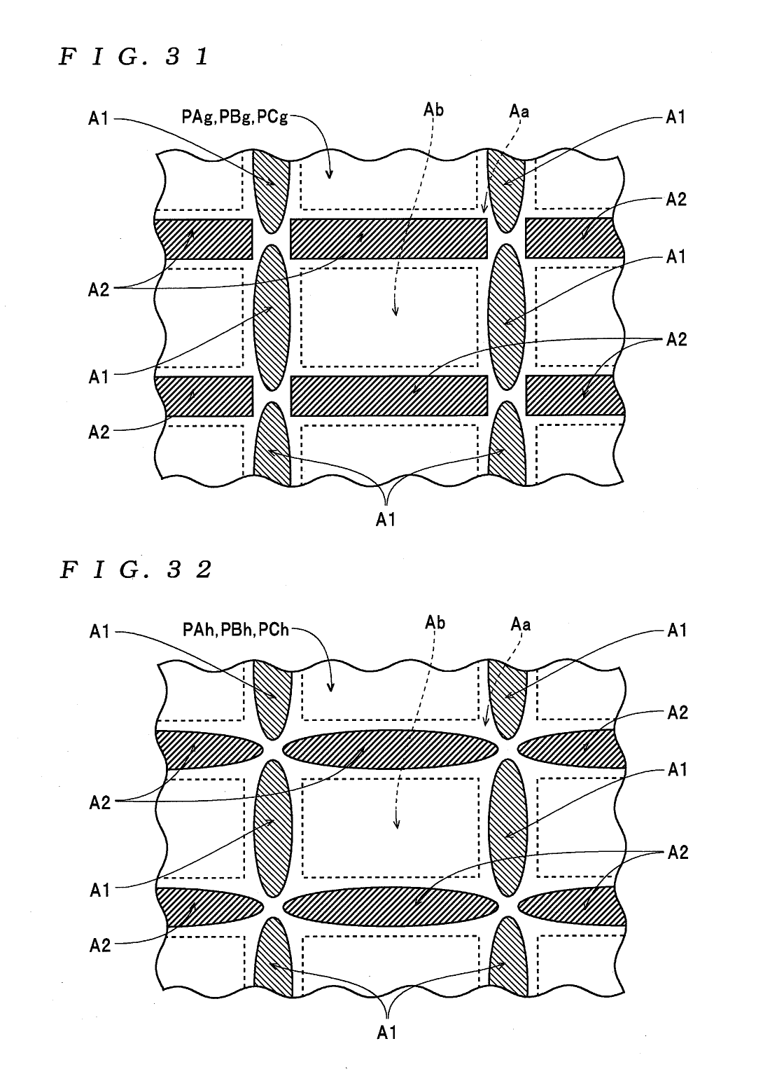

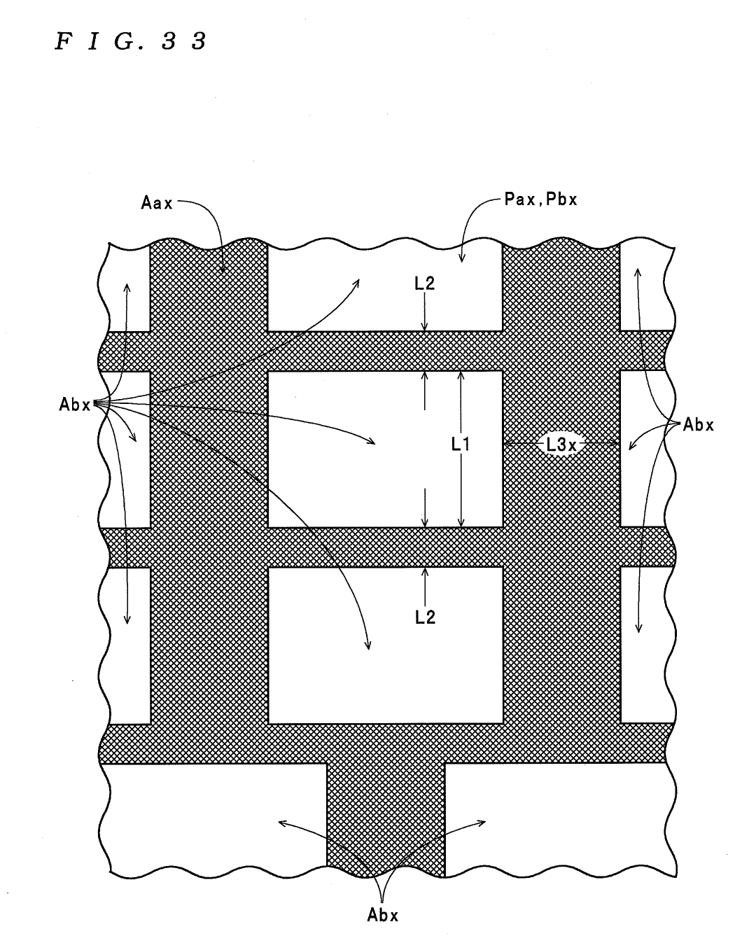

The electron beam drawing apparatus (hereinafter also simply “drawing apparatus”) 1 shown in FIG. 1 is constructed so as to be capable of drawing exposure patterns PA, PB, PC (examples of “patterns” for the present invention) shown in FIG. 6 in accordance with a drawing method described later when manufacturing a stamper 40 (see FIG. 3) used when manufacturing magnetic disks 110A, 110B, 110C (examples of an “information recording medium” for the present invention) shown in FIG. 2. Note that in FIG. 6 and in FIGS. 7, 8, and 20 to 32 that will be referred to later, positions that correspond to parts (as one example, burst patterns) of servo patterns of the magnetic disks 110A, 110B, 110C are shown out of exposure patterns PA, PAa to PAh, PB, PBa to PBh, PC, PCb to PCh.

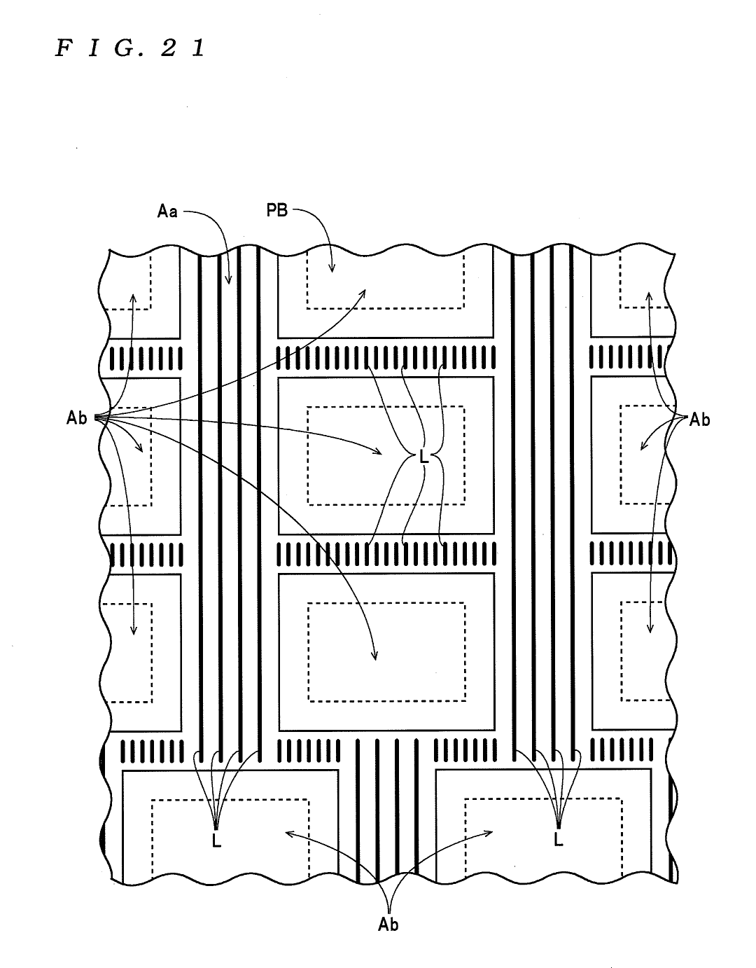

In this case, the magnetic disks 110A, 110B, 110C are discrete track-type patterned media and are housed inside a case (not shown) together with recording/reproducing heads, a motor, and the like to construct a magnetic recording apparatus (hard disk drive). Note that the magnetic disk 110A is manufactured using a stamper 40 manufactured by drawing the exposure pattern PA shown in FIG. 7, the magnetic disk 110B is manufactured using a stamper 40 manufactured by drawing the exposure pattern PB shown in FIG. 21, and the magnetic disk 110C is manufactured using a stamper 40 manufactured by drawing the exposure pattern PC shown in FIG. 24. Hereinafter, the magnetic disks 110A, 110B, and 110C are collectively referred to as the “magnetic disk 110” when no distinction is made therebetween. Also, the exposure patterns PA, PB, and PC are collectively referred to as the “exposure pattern P” when no distinction is made therebetween. As shown in FIG. 2, the magnetic disk 110 is constructed by forming a soft magnetic layer 112, an intermediate layer 113, and a magnetic layer 114 in the mentioned order on a substrate 111, has a concave/convex pattern 125 of data track patterns, servo patterns, and the like formed thereupon by convexes 126 and concaves 127 formed in the magnetic layer 114, and is capable of recording data according to perpendicular recording.

The stamper 40 is a resin stamper that is used during an imprinting process, is manufactured using an exposure pattern P drawn by the electron beam drawing apparatus 1 as described later, and is constructed so as to be capable of forming a concave/convex pattern 145 (one example of a “mask concave/convex pattern”: mask pattern, see FIG. 15) for use during an etching process in a B mask layer 118 formed on a preform 100 shown in FIG. 4 when manufacturing the magnetic disk 110. More specifically, as shown in FIG. 3, a concave/convex pattern 45 with plural concaves 47 corresponding to the convexes 126 of the concave/convex pattern 125 of the magnetic disk 110 described above and plural convexes 46 corresponding to the concaves 127 of the concave/convex pattern 125 is formed on the stamper 40. Note that the method of manufacturing the stamper 40 and the method of manufacturing the magnetic disk 110 using the stamper 40 and the preform 100 will be described in detail later.

On the other hand, as shown in FIG. 1, the electron beam drawing apparatus 1 includes an X-Y moving mechanism 2, a turntable 3, a beam generating unit 4, a blanking control unit 5, a beam shaping unit 6, a beam deflecting unit 7, a control unit 8, and a storage unit 9, and is constructed so as to be capable of outputting an electron beam EB (one example of a “drawing beam”) from the beam generating unit 4 to draw the exposure pattern P on a workpiece 10 (see FIG. 5). In this case, the workpiece 10 is a plate member that forms a concave/convex pattern 15 (one example of a “first concave/convex pattern” for the present invention: see FIG. 9) for manufacturing a stamper 20 (“master stamper”: see FIG. 11) for manufacturing the stamper 40 described above, and as shown in FIG. 5, has a resin layer 12 (as one example, a resist layer formed by applying a positive resist that is sensitive to an electron beam) formed on the surface of a disc-shaped silicon base plate 11 (one example of a “substrate” for the present invention).

Together with the beam deflecting unit 7, the X-Y moving mechanism 2 constructs an “irradiated position changing unit” for the present invention, and by moving the turntable 3 on the plane of the workpiece 10 that is being rotated by the turntable 3 in accordance with control by the control unit 8, the X-Y moving mechanism 2 changes the position on the resin layer 12 to be irradiated with the electron beam EB (i.e., a position that is relatively passed by a beam center of the electron beam EB). The turntable 3 corresponds to a “rotating mechanism” for the present invention, is constructed so that the workpiece 10 can be mounted thereupon, and rotates the workpiece 10 in accordance with control by the control unit 8. Together with the blanking control unit 5, the beam generating unit 4 constructs a “beam emitting unit” for the present invention, and generates and outputs the electron beam EB for drawing the exposure pattern P on the resin layer 12 of the workpiece 10. The blanking control unit 5 carries out on/off control over the outputting of the electron beam EB by the beam generating unit 4 in accordance with control by the control unit 8. The beam shaping unit 6 includes a beam shaping lens, an aperture (not shown), and the like, and shapes (i.e., focuses) the electron beam EB outputted by the beam generating unit 4.

The beam deflecting unit 7 deflects the electron beam EB shaped by the beam shaping unit 6 in accordance with control by the control unit 8 to change the irradiated position (i.e., the position that is relatively passed by the beam center of the electron beam EB) of the electron beam EB on the resin layer 12. The control unit 8 controls the X-Y moving mechanism 2 to move the turntable 3 and the workpiece 10 and controls the turntable 3 to rotate the workpiece 10 at a constant rotational velocity (as one example, a constant linear velocity). The control unit 8 also controls the beam generating unit 4, the blanking control unit 5, and the beam deflecting unit 7 to emit the electron beam EB onto a predetermined position on the resin layer 12 of the workpiece 10 being rotated by the turntable 3. The storage unit 9 stores drawing procedure data DP that is capable of specifying a drawing procedure of the exposure pattern P that is to be drawn on the workpiece 10. The drawing procedure data DP includes data that is capable of specifying the timing for starting emission of the electron beam EB and the timing of stopping emission of the electron beam EB to the blanking control unit 5, the timing and moved distance for movement of the turntable 3 to the X-Y moving mechanism 2, and the timing and deflection amount (irradiation pitches P1 to P3, described later) for deflection of the electron beam EB to the beam deflecting unit 7.

Next, the method of manufacturing the stamper 40 for manufacturing the magnetic disk 110A and the method of manufacturing the magnetic disk 110A using the stamper 40 will be described with reference to the drawings.

First, the workpiece 10 on which the exposure pattern PA is to be drawn is fabricated. More specifically, as one example, the resin layer (resist layer) 12 is formed on the silicon base plate 11 by spin-coating an electron beam drawing resist (a positive resist: as one example, “ZEP520A” made by ZEON CORPORATION of Japan) so that the thickness after a baking process on one surface of the silicon base plate 11 is around 60 nm. Next, the applied resin layer 12 is subjected to the baking process. By doing so, the workpiece 10 is completed. After this, the fabricated workpiece 10 is placed on the turntable 3 of the drawing apparatus 1 with the surface on which the resin layer 12 has been formed facing upwards, and a two-dimensional pattern (data track patterns and servo patterns: the exposure pattern PA shown in FIG. 6) corresponding to the convexes 46 of the concave/convex pattern 45 of the stamper 40 is drawn on the resin layer 12 by emitting the electron beam EB as shown in FIG. 5.

More specifically, when the start of drawing has been indicated, the control unit 8 controls the X-Y moving mechanism 2 to move the turntable 3 in accordance with the drawing procedure data DP stored in the storage unit 9 so that as one example, an innermost position in a ring-shaped region in which the exposure pattern PA is to be drawn is moved below the beam generating unit 4. Next, the control unit 8 controls the turntable 3 to rotate the workpiece 10 according to the condition of a constant linear velocity of 180 mm/sec for example, and controls the beam generating unit 4, the blanking control unit 5, and the beam deflecting unit 7 to emit the electron beam EB onto the workpiece 10 (the resin layer 12) upon the turntable 3 as shown in FIG. 5. When doing so, by emitting the electron beam EB onto the resin layer 12 while the workpiece 10 is rotating, the beam center of the electron beam EB moves relative to the resin layer 12 in the direction in which the resin layer 12 is rotating. As a result, the electron beam EB is emitted onto a long belt-shaped region along the direction of rotation of the workpiece 10.

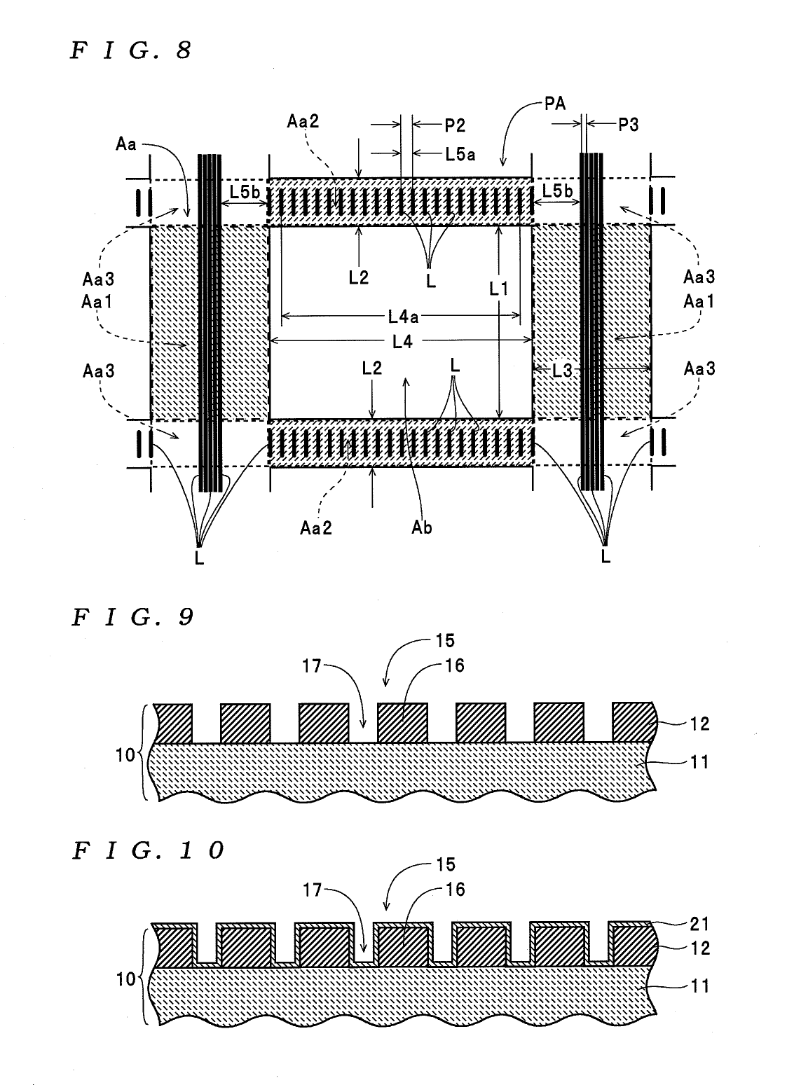

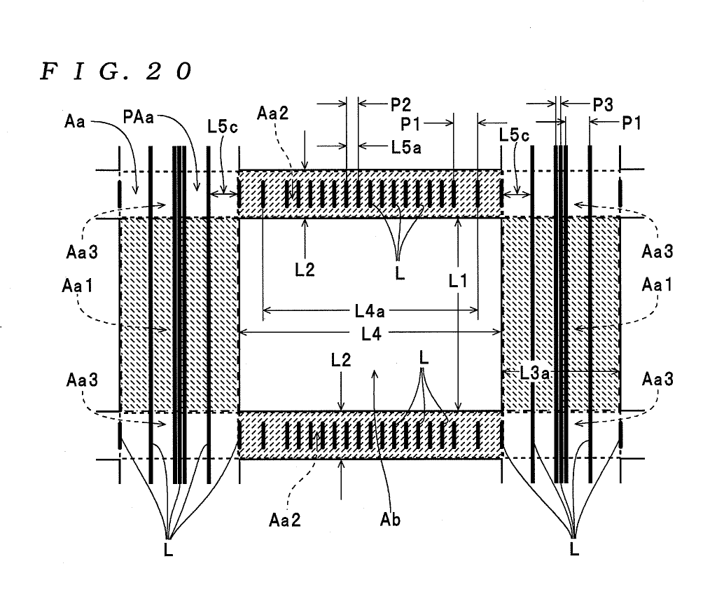

By successively exposing plural belt-shaped regions that are adjacent in the radial direction of the workpiece 10, the control unit 8 emits the electron beam EB so as to expose the entire range of each of the exposed regions Aa (see FIG. 6). More specifically, the control unit 8 specifies the pitch in the radial direction in the belt-shaped regions used to expose the respective exposed regions Aa (that is, the pitch in the radial direction of the beam center of the electron beam EB) based on the drawing procedure data DP, and controls the beam deflecting unit 7 to emit the electron beam EB onto the workpiece 10. In this case, as shown in FIG. 6, when drawing at positions where plural unexposed regions Ab are aligned in the direction of rotation of the workpiece 10 (the up-down direction in FIG. 6) and the radial direction of the workpiece 10 (the left-right direction in FIG. 6) in the exposure pattern PA, as shown in FIG. 7, the control unit 8 changes the irradiation pitch in the radial direction (the distance in the left-right direction between the thick lines L in FIG. 7) of the electron beam EB in the exposed regions Aa between the unexposed regions Ab in accordance with the positions of the exposed regions Aa relative to the unexposed regions Ab. Note that in FIG. 7 and in FIGS. 8 and 20 described later, the paths relatively traced by the beam center of the electron beam EB emitted onto the resin layer 12 when drawing the exposure patterns PA, PAa are shown by the thick lines L.

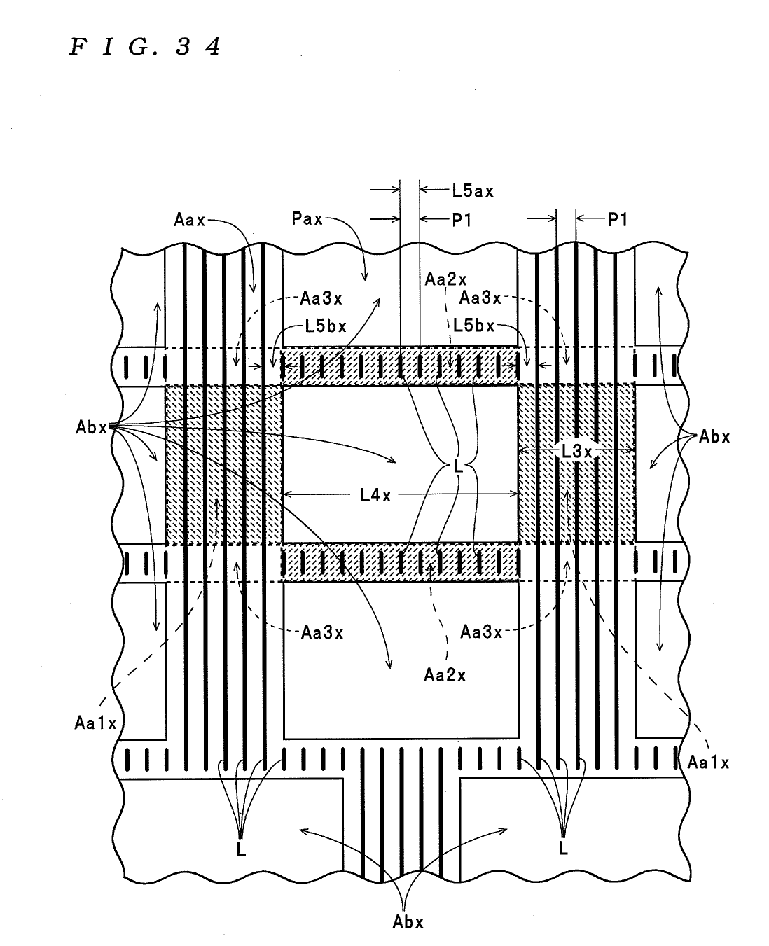

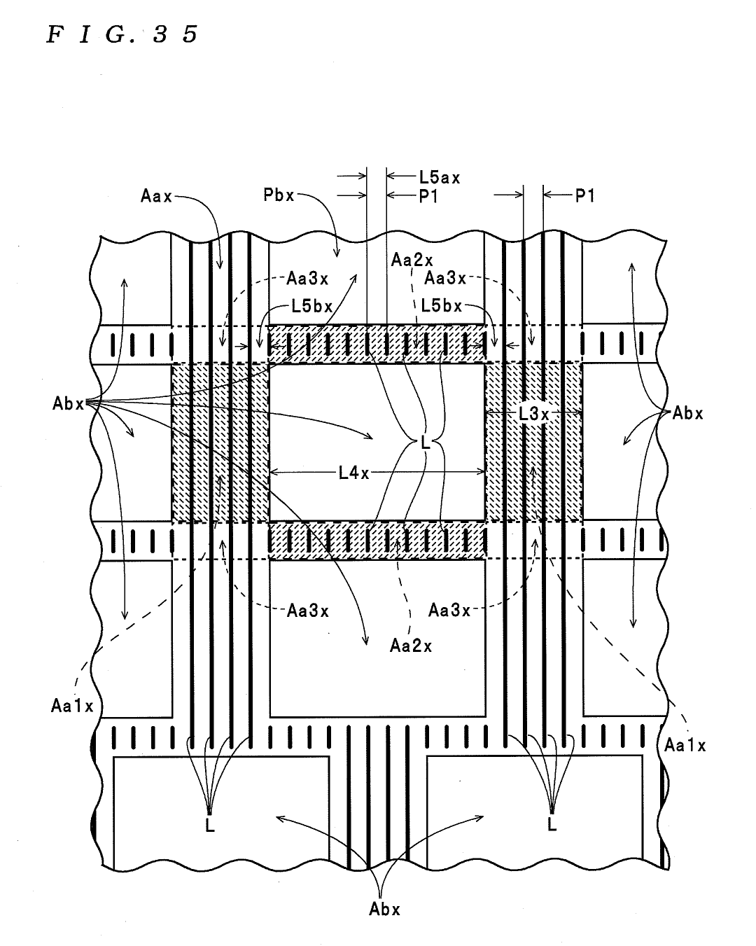

More specifically, as shown in FIG. 8, when drawing at a position where a predetermined region out of plural unexposed regions Ab (as one example, the unexposed region Ab in the upper center in FIG. 7) is surrounded by four exposed regions Aa composed of two exposed regions Aa1 (examples of “first exposed regions” for the present invention) that contact such unexposed region Ab in the radial direction (the left-right direction in FIG. 8) and two exposed regions Aa2 (examples of “second exposed regions” for the present invention) that contact such unexposed region Ab in the direction of rotation (the up-down direction in FIG. 8) and where the length L2 along the direction of rotation (a “second length” for the present invention: as one example, 30 nm) of at least one out of the two exposed regions Aa2 (in this example, both regions) is shorter than the length L1 along the direction of rotation (a “first length” for the present invention: as one example, 100 nm) of at least one out of the two exposed regions Aa1 (in this example, both regions), the control unit 8 controls the beam deflecting unit 7 to emit the electron beam EB onto the resin layer 12 so that the average irradiation pitch (a “second average irradiation pitch of the drawing beam emitted onto the second regions”: in this example, irradiation pitch P2) of the electron beam EB emitted onto regions to become the exposed regions Aa2 (a “second region” for the present invention: regions that are diagonally shaded with broken lines from top right in FIG. 8) is narrower than the average irradiation pitch (in this example, the irradiation pitch P1) of the electron beam emitted onto regions to become exposed regions Aa2x (regions that are diagonally shaded with broken lines from top right in FIG. 34) when drawing an exposure pattern Pax in accordance with the conventional drawing method.

When drawing the exposure pattern PA, the control unit 8 emits the electron beam EB onto the resin layer 12 so that the average irradiation pitch (“the first average irradiation pitch of the drawing beam emitted onto the first regions”: in this example, the irradiation pitch P3) of the electron beam EB emitted onto the regions to become the exposed regions Aa1 (a “first region” for the present invention: regions that are diagonally shaded with broken lines from top left in FIG. 8) is narrower than the average irradiation pitch (in this example, the irradiation pitch P2) of the electron beam EB emitted onto the regions to become the exposed regions Aa2. More specifically, the control unit 8 controls the beam deflecting unit 7 in accordance with the drawing procedure data DP so that as one example, when the irradiation pitch P1 described earlier is set at 8.0 nm, the irradiated position (a position on the resin layer 12 that is relatively passed by the beam center of the electron beam EB) in the radial direction of the electron beam EB is changed so that the irradiation pitch P3 described above is 0 nm and the irradiation pitch P2 described above is 5.6 nm. Note that in this example, the regions (for example, regions where the electron beam is emitted with an irradiation pitch such as P1 or P2) on which the electron beam EB is emitted with an irradiation pitch that is not the irradiation pitch P3 (0 nm) correspond to “at least part of the substrate” for the present invention.

In FIGS. 7 and 8, for ease of understanding the drawing method, the five thick lines L that represent the paths that are relatively traced by the beam center when the electron beam EB is emitted five times to draw the exposed regions Aa1 or the like are depicted using separate lines that are shifted in the radial direction. In reality however, since the irradiation pitch P3 is 0 nm as described above, the beam center will relatively pass above the same line (as one example, the thick line L positioned in the center in the radial direction out of the five thick lines L described above). Note that in the exposure pattern PA shown in FIGS. 7 and 8, parts of exposed regions Aa that are positioned in the radial direction (in this example, the left-right direction in both drawings) relative to a predetermined one of the unexposed regions Ab (in this example, the upper center unexposed region Ab in FIG. 7) and have a length along the direction of rotation (in this example, the up-down direction in both drawings) that is longer than a length along the direction of rotation (in this example, the length L1) of the predetermined unexposed region Ab (in this example, such “parts of exposed regions Aa” are bordered by a pair of virtual extended lines produced by extending both edges that face each other along the radial direction (i.e., both edges that extend in the left-right direction in the drawings) of the predetermined unexposed region Ab described above) are set as “exposed regions Aa1” that correspond to the “first exposed regions” for the present invention. In other words, a state is shown where exposed regions Aa are positioned so as to be continuous at both ends in the direction of rotation of a “first exposed region”.

Also, in the exposure pattern PA shown in FIGS. 7 and 8, parts of exposed regions Aa that are positioned in the direction of rotation (in this example, the up-down direction in both drawings) relative to a predetermined one of the unexposed regions Ab (in this example, the upper center unexposed region Ab in FIG. 7) and have a length along the radial direction (in this example, the left-right direction in both drawings) that is longer than a length along the radial direction (in this example, the length L2) of the predetermined unexposed region Ab (in this example, such “parts of exposed regions Aa” are bordered by a pair of virtual extended lines produced by extending both edges that face each other along the direction of rotation (i.e., both edges that extend in the up-down direction in the drawings) of the predetermined unexposed region Ab described above) are set as “exposed regions Aa2” that correspond to the “second exposed regions” for the present invention. In other words, a state is shown where exposed regions Aa are positioned so as to be continuous at both ends in the radial direction of a “second exposed region”.

Also, in the drawing procedure data DP described above, as shown in FIG. 7, as one example, for the exposed regions Aa (i.e., the exposed regions Aa3: see FIG. 8) that contact the exposed regions Aa1 described above in the direction of rotation (i.e., are continuous with the exposed regions Aa1 in the direction of rotation), the drawing procedure is recorded so that the electron beam EB is emitted for the same number of times with the same irradiation pitch P3 as the irradiation pitch P3 of the electron beam EB in the exposed regions Aa1. Also, for exposed regions Aa at positions that are not shown in FIGS. 7 and 8 (regions aside from the burst pattern regions of the servo pattern regions and/or regions that correspond to track pattern regions or the like), the drawing procedure is recorded so that the electron beam EB is emitted with a predetermined irradiation pitch in accordance with the pattern at such positions.

As shown in FIG. 34, the electron beam is irradiated with the same irradiation pitch P1 in both the exposed regions Aa1x, Aa2x according to the drawing method disclosed by the present applicant (the “conventional drawing method”). Accordingly, if the number of times the electron beam is emitted onto a region to become an exposed region Aa1x is set at Nx (where Nx is a natural number of two or higher), the length (a length corresponding to the “third length”) along the radial direction of the region to become the exposed region Aa1x is set at L3x, the number of times the electron beam is emitted onto a region to become an exposed region Aa2x is set at Mx (where Mx is a natural number of two or higher), and the length along the radial direction (i.e., a length corresponding to the “fourth length”: in this example, a length that is equal to the length along the radial direction of the unexposed region Abx) between the beam center when the electron beam is emitted onto the innermost periphery (as one example, the leftmost position in the drawing) in the radial direction of the region to become the exposed region Aa2x out of the Mx times the electron beam is emitted and the beam center when the electron beam is emitted onto the outermost periphery (as one example, the rightmost position in the drawing) in the radial direction of the region to become the exposed region Aa2x is set at the length L4x, according to the conventional drawing method, the electron beam is emitted onto the resin layer so that the value produced by dividing the length L3x by (Nx+1) and the value produced by dividing the length L4x by (Mx−1) are equal.

On the other hand, as shown in FIG. 8, according to the drawing method for the exposure pattern PA, the average irradiation pitch (in this example, the irradiation pitch P3) of the electron beam EB emitted onto regions to become the exposed regions Aa1 is narrower than the average irradiation pitch (in this example, the irradiation pitch P2) of the electron beam EB emitted onto regions to become the exposed regions Aa2. Here, according to the drawing method for the exposure pattern PA, if the number of times the electron beam EB is emitted onto a region to become an exposed region Aa1 is set at N (in this example, N=5), the length along the radial direction of the region to become the exposed region Aa1 is set at L3 (the “third length”: as one example, 48.0 nm), the number of times the electron beam EB is emitted onto a region to become an exposed region Aa2 is set at M (in this example, M=23), and the length along the radial direction between the beam center when the electron beam EB is emitted onto the innermost periphery (as one example, the leftmost position in the drawing) in the radial direction of the region to become the exposed region Aa2 out of the M times the electron beam EB is emitted and the beam center when the electron beam EB is emitted onto the outermost periphery (as one example, the rightmost position in the drawing) in the radial direction of the region to become the exposed region Aa2 is set at the length L4 (the “fourth length”: as one example, 123.2 nm), with the drawing method for the exposure pattern PA, the electron beam EB is emitted so that the value (in this example, 5.6) produced by dividing the length L4 by (M−1) is lower than the value (in this example, 8.0) produced by dividing the length L3 by (N+1).

Note that with the drawing method for the exposure pattern PA, even if the emissions where the beam center of the electron beam EB matches the end in the radial direction of the region to become the exposed region Aa2 are not counted in the “number of emissions of the electron beam EB emitted on a region to become a exposed region Aa2”, the condition that “the value produced by dividing the fourth length by (M−1) is lower than the value produced by dividing the third length by (N+1)” will still be satisfied. More specifically, if the number of emissions of the electron beam EB emitted onto the regions to become the exposed regions Aa2 is set at twenty-one, which is two lower than in the example described above, and the length along the radial direction between the beam center when the electron beam EB is emitted onto the innermost periphery in the radial direction of the region to become the exposed region Aa2 out of the twenty-one times the electron beam is emitted and the beam center when the electron beam EB is emitted onto the outermost periphery in the radial direction of the region to become the exposed region Aa2 is set at the length L4a (as one example, 112.0 nm), for the drawing method for the exposure pattern PA, the value (in this example, 5.6) produced by dividing the length L4a by (M−1=20) will be lower than the value (in this example, 8.0) produced by dividing the length L3 by (N+1) described above.

Here, as described earlier, with the exposure pattern PA described above, the length L2 along the direction of rotation of the exposed regions Aa2 is shorter than the length L1 along the direction of rotation of the exposed regions Aa1. This means that when the exposure pattern PA is drawn, during one emission (scan) of the electron beam EB, the distance (that is, irradiation time) on the resin layer 12 for which the electron beam EB is emitted onto the exposed regions Aa2 is shorter than the distance (irradiation time) on the resin layer 12 for which the electron beam EB is emitted onto the exposed regions Aa1. Accordingly, by emitting the electron beam EB with the same irradiation pitch P1 in the exposed regions Aa1, Aa2 according to the conventional drawing method, if the electron beam EB is emitted so that the value produced by dividing the length L3 along the radial direction of a region to become an exposed region Aa1 by a value given by adding one to the number of emissions of the electron beam EB emitted onto the region to become the exposed region Aa1 is equal to the value produced by dividing the length L4 along the radial direction between the beam center during emission of the electron beam EB at the innermost position in the radial direction out of the plural emissions on a region to become an exposed region Aa2 and the beam center during emission of the electron beam EB on the outermost position in the radial direction by a value given by subtracting one from the number of emissions of the electron beam EB on the region to become the exposed region Aa2, there is the risk that the amount of irradiation will be insufficient in the exposed regions Aa2 described above where the distance (irradiation time) on the resin layer 12 irradiated by the electron beam EB is short.

On the other hand, with the drawing method for the exposure pattern PA using the electron beam drawing apparatus 1, as described above, the electron beam EB is emitted onto the exposed regions Aa1, Aa2 so that a value (in this example, 5.6) produced by dividing the length L4 along the radial direction between the beam center during emission of the electron beam EB on the innermost position in the radial direction out of the multiple emissions on a region to become an exposed region Aa2 where the irradiation distance (irradiation time) of the electron beam EB is short and the beam center during emission of the electron beam EB on the outermost position in the radial direction by a value given by subtracting one from the number of emissions of the electron beam EB on the region to become the exposed region Aa2 is lower than a value (in this example, 8.0) produced by dividing the length L3 along the radial direction of a regions to become an exposed region Aa1 where the irradiation distance (irradiation time) of the electron beam EB is long by a value given by adding one to the number of emissions of the electron beam EB emitted onto the region to become the exposed region Aa1. Accordingly, the electron beam EB is sufficiently emitted onto the exposed regions Aa2, where the irradiation distance (irradiation time) of the electron beam EB is short, with the same or a higher amount of irradiation as the exposed regions Aa1.

In the drawing method for the exposure pattern PA according to the electron beam drawing apparatus 1, as described above, the electron beam EB is irradiated on the exposed regions Aa1, Aa2 so that the irradiation pitch P3 of the electron beam EB on the exposed regions Aa1 is also narrower than the irradiation pitch P2 of the electron beam EB on the exposed regions Aa2. Here, as described earlier, the irradiation pitch P2 of the electron beam EB on the exposed regions Aa2 is narrower than the irradiation pitch P1 of the electron beam EB on the exposed regions Aa1x, Aa2x when drawing the exposure pattern Pax according to the conventional drawing method. Accordingly, it is possible to make the length L3 along the radial direction of the exposed regions Aa1 sufficiently short. Also, as described earlier, according to the drawing method for the exposure pattern PA, the distance (irradiation time) for which the electron beam EB is emitted onto the resin layer 12 in regions to become the exposed regions Aa1 is sufficiently longer than the distance (irradiation time) for which the electron beam EB is emitted onto the resin layer 12 in regions to become the exposed regions Aa2. Accordingly, the electron beam EB is sufficiently emitted onto the regions to become the exposed regions Aa1, and as a result, it is possible to widen the region where a sufficient exposure level is reached in the radial direction from the center in the radial direction and form the exposed regions Aa1 where the length in the radial direction is the intended length (in this example, the length L3).

Here, with the conventional drawing method (the drawing method for the exposure pattern Pax), as described earlier, the electron beam is emitted with the same irradiation pitch P1 onto both the exposed regions Aa1x and Aa2x. For this reason, as shown in FIG. 34, with the conventional drawing method, the electron beam EB is emitted so that a length L5bx along the radial direction between (i) a virtual extended line along the direction of rotation for the beam center during emission of the electron beam EB on the outermost (or innermost) position in the radial direction in a “first region” to become an exposed region Aa1x out of the multiple emissions of the electron beam EB when drawing the exposure pattern Pax and (ii) the closest beam center that is positioned on the outside (or inside) in the radial direction to the virtual extended line described above out of the beam centers out of the multiple emissions of the electron beam EB when drawing the exposure pattern Pax (in this example, the beam center when the electron beam EB is emitted onto an innermost (or outermost) position in the radial direction of a “second region” to become an exposed region Aa2x) is equal to a length L5ax along the radial direction between the beam centers during the multiple emissions of the electron beam EB on the second region (a length corresponding to the irradiation pitch P1 described earlier, in this example, a length corresponding to the average irradiation pitch of the electron beam EB on the second region).

Also, with the conventional drawing method, the electron beam EB is emitted onto a “third region” to become an exposed region Aa3x that is located between two exposed regions Aa1x, Aa1x that are adjacent in the direction of rotation and between two exposed regions Aa2x, Aa2x that are adjacent in the radial direction continuously from a first region that is adjacent to the third region in the direction of rotation without stopping the emission of the electron beam EB. Therefore, according to the conventional drawing method, the beam center during emission of the electron beam EB on the outermost (or innermost) position in the radial direction of a third region will coincide with a virtual extended line along the direction of rotation of the beam center during emission of the electron beam EB on the outermost (or innermost) position in the radial direction of a first region. This means that with the conventional drawing method, the electron beam EB is emitted so that the length L5bx along the radial direction between the beam center during emission of the electron beam EB on the outermost (or innermost) position in the radial direction of the third region and the beam center that is closest to such beam center on the outside (or inside) thereof in the radial direction (in this example, the beam center when the electron beam EB is emitted at the innermost (or outermost) position in the radial direction of a second region) is equal to the length L5ax along the radial direction between the beam centers during the multiple emissions of the electron beam EB on the second region.

On the other hand, as shown in FIG. 8, with the drawing method for the exposure pattern PA, the electron beam EB is emitted so that the length L5b along the radial direction between (i) a virtual extended line along the direction of rotation of the beam center during emission of the electron beam EB on the outermost (or innermost) position in the radial direction in a “first region” to become an exposed region Aa1 out of the multiple emissions of the electron beam EB when drawing the exposure pattern PA and (ii) the closest beam center that is positioned on the outside (or inside) in the radial direction to the virtual extended line described above out of the beam centers during the multiple emissions of the electron beam EB when drawing the exposure pattern PA (in this example, the beam center during emission of the electron beam EB at the innermost (or outermost) position in the radial direction of a “second region” to become an exposed region Aa2) is longer than the length L5a (a length corresponding to the irradiation pitch P2 described earlier, and in this example, a length corresponding to the average irradiation pitch of the electron beam EB in the second regions) along the radial direction between the beam centers during the multiple emissions of the electron beam EB in the second regions (i.e., so that the length L5a is shorter than the length L5b).

Also according to the drawing method for the exposure pattern PA, the electron beam EB is emitted onto a “third region” to become an exposed region Aa3 that is located between two exposed regions Aa1, Aa1 that are adjacent in the direction of rotation and between two exposed regions Aa2, Aa2 that are adjacent in the radial direction continuously from a first region that is adjacent to the third region in the direction of rotation without stopping the emission of the electron beam EB. Therefore, with the drawing method for the exposure pattern PA, the beam center during emission of the electron beam EB on the outermost (or innermost) position in the radial direction of a third region will coincide with a virtual extended line along the direction of rotation of the beam center during emission of the electron beam EB on the outermost (or innermost) position in the radial direction of a first region. This means that with the drawing method for the exposure pattern PA, the electron beam EB is emitted so that the length L5b along the radial direction between the beam center during emission of the electron beam EB on the outermost (or innermost) position in the radial direction of the third region and the beam center that is closest to such beam center on the outside (or inside) thereof in the radial direction (in this example, the beam center when the electron beam EB is emitted at the innermost (or outermost) position in the radial direction of the second region) is longer than the length L5a along the radial direction between the beam centers during multiple emissions of the electron beam EB in the second region (i.e., so that the length L5a is shorter than the length L5b).

After this, the control unit 8 carries out a process that emits the electron beam EB onto the resin layer 12 along the direction of rotation of the workpiece 10 multiple times at a predetermined irradiation pitch. Note that when it is necessary for the beam deflecting unit 7 to deflect the irradiated position of the electron beam EB in excess of a permitted deflection amount for the electron beam EB, the control unit 8 controls the X-Y moving mechanism 2 to move the turntable 3 so as to change the position of the workpiece 10 relative to the beam generating unit 4, the blanking control unit 5, the beam shaping unit 6, and the like. In this way, by controlling the X-Y moving mechanism 2 and the beam deflecting unit 7 in accordance with the drawing procedure data DP to adjust the irradiation pitch of the electron beam EB on the workpiece 10 and controlling the blanking control unit 5 to carry out blanking control over emission of the electron beam EB while controlling the turntable 3 to rotate the workpiece 10, the electron beam EB is successively emitted up to the outermost region of the workpiece 10 so as to form a latent image inside the exposed regions Aa that construct the data track patterns and the servo patterns. By doing so, the drawing process of the servo patterns and data track patterns (that is, the exposure pattern PA) is completed.

Next, a developing process is carried out on the resin layer 12 on which the drawing of the exposure pattern PA has been completed. More specifically, as one example, “ZED-N50” made by ZEON CORPORATION of Japan is used as a developer and the workpiece 10 on which the drawing of the exposure pattern PA has been completed is soaked for forty-five seconds in a state where the developer is kept at 18° C. When doing so, the resin layer 12 at the positions irradiated with the electron beam EB react with the developer and are removed from the silicon base plate 11 so that as shown in FIG. 9, a concave/convex pattern 15 (one example of a “first concave/convex pattern”) with plural convexes 16 composed of the resin layer 12 remaining on the silicon base plate 11 and plural concaves 17 formed by removal of the resin layer 12 is formed on the silicon base plate 11. Here, as described earlier, when drawing the exposure pattern PA, by sufficiently emitting the electron beam EB onto the exposed regions Aa1 that are susceptible to insufficient exposure due to the length L3 along the radial direction being short and onto the exposed regions Aa2 that are susceptible to insufficient exposure with the conventional drawing method, a situation where the amount of exposure is insufficient in the exposed regions Aa1 and Aa2 is avoided. Accordingly, a situation where the resin layer 12 remains on the silicon base plate 11 in the exposed regions Aa1 and Aa2 that are supposed to react with the developer and be removed from the silicon base plate 11 and thereby forms unnecessary convexes 16 at positions where concaves 17 should be formed (for example, a situation where the convexes 16 that correspond to the unexposed regions Ab are connected in the direction of rotation and/or the radial direction) is avoided. Next, the workpiece 10 on which the concave/convex pattern 15 has been formed is removed from the developer and is spin-dried using isopropyl alcohol as a rinse. By doing so, a matrix for manufacturing the stamper 40 is completed.

After this, as shown in FIG. 10, after forming a nickel layer (conductive layer) 21 by carrying out a vapor deposition process, for example, on the surface of the concave/convex pattern 15, an electroplating process (electrocasting process) is carried out using the nickel layer 21 as an electrode. When doing so, as shown in FIG. 11, the concave/convex pattern 15 formed on the silicon base plate 11 (the resin layer 12) by the developing process is transferred to a layer of nickel (the nickel layers 21, 22) so that convexes 26 whose two-dimensional form is substantially the same as the exposed regions Aa described above are formed. Note that in place of the above method that forms the nickel layer (conductive layer) 21 on the surface of the concave/convex pattern 15, it is also possible to use a method that forms a concave/convex pattern (not shown) where the positional relationship of the concaves and convexes is the same as in the concave/convex pattern 15 on the silicon base plate 11 by carrying out an etching process using the concave/convex pattern 15 and forming the nickel layer (conductive layer) 21 on the surface of such concave/convex pattern. In such case, since the concave/convex pattern 15 is formed so that unnecessary convexes 16 (defects) are not present, the concave/convex pattern formed in the silicon base plate 11 corresponding to the concave/convex pattern 15 will also be formed with high precision without unnecessary convexes (defects) being formed at positions where concaves should be formed.

After this, by separating the laminated body composed of the nickel layers 21, 22 from the workpiece 10 (the silicon base plate 11), a stamper 20 on which is formed a concave/convex pattern 25 (one example of a “second concave/convex pattern”) with plural concaves 27 that correspond to the convexes 16 in the concave/convex pattern 15 described above formed on the silicon base plate 11 described above (or that correspond to the convexes in the concave/convex pattern formed in the silicon base plate 11 by the etching process that uses the concave/convex pattern 15) and plural convexes 26 that correspond to the concaves 17 in the concave/convex pattern 15 (or that correspond to the concaves in the concave/convex pattern formed in the silicon base plate 11 by the etching process that uses the concave/convex pattern 15) is completed. Here, since the concave/convex pattern 15 (or the concave/convex pattern formed using the concave/convex pattern 15) is formed so that unnecessary convexes 16 (defects) are not present, the concave/convex pattern 25 formed corresponding to the concave/convex pattern 15 will also be formed with high precision without unnecessary concaves 27 (defects) being formed at positions where the convexes 26 should be formed.

After this, an electroplating process (electrocasting process) is carried out using the completed stamper 20 as an electrode. When doing so, as shown in FIG. 12, the concave/convex pattern 25 of the stamper 20 is transferred to a layer of nickel (the nickel layer 31) to form a concave/convex pattern 35 (another example of a “second concave/convex pattern”) with plural concaves 37 corresponding to the convexes 26 of the concave/convex pattern 25 and plural convexes 36 corresponding to the concaves 27 of the concave/convex pattern 25. After this, by separating the nickel layer 31 from the stamper 20, a stamper 30 (“mother stamper”) is completed. Here, since the concave/convex pattern 25 is formed so that unnecessary concaves 27 (defects) are not present, the concave/convex pattern 35 formed corresponding to the concave/convex pattern 25 will also be formed with high precision without unnecessary convexes 36 (defects) being formed at positions where the concaves 37 should be formed.

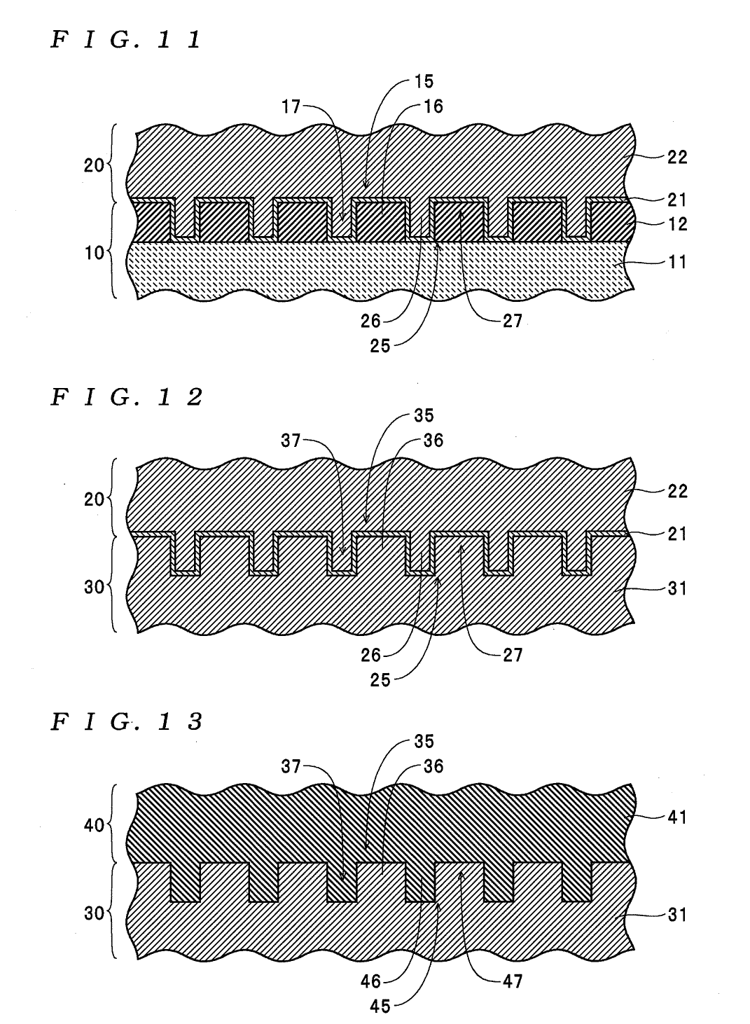

After this, the completed stamper 30 is set in an injection molding apparatus, not shown, and an injection molding process (one example of a “predetermined procedure” for the present invention), is carried out. When doing so, as shown in FIG. 13, the concave/convex pattern 35 (one example of a “concave/convex pattern formed using a concave/convex pattern formed on the substrate”) of the stamper is transferred to a resin material 41 (one example of a “stamper forming member”) to form a concave/convex pattern 45 with plural concaves 47 corresponding to the convexes 36 in the concave/convex pattern 35 and plural convexes 46 corresponding to the concaves 37 in the concave/convex pattern 35. After this, by separating the resin material 41 from the stamper 30, as shown in FIG. 3, the stamper 40 (“child stamper”) is completed. Here, since the concave/convex pattern 35 is formed so that unnecessary convexes 36 (defects) are not present, the concave/convex pattern 45 formed corresponding to the concave/convex pattern 35 will also be formed with high precision without unnecessary concaves 47 (defects) being formed at positions where the convexes 46 should be formed. This completes the series of processes that manufacture the stamper 40 for manufacturing the magnetic disk 110A.

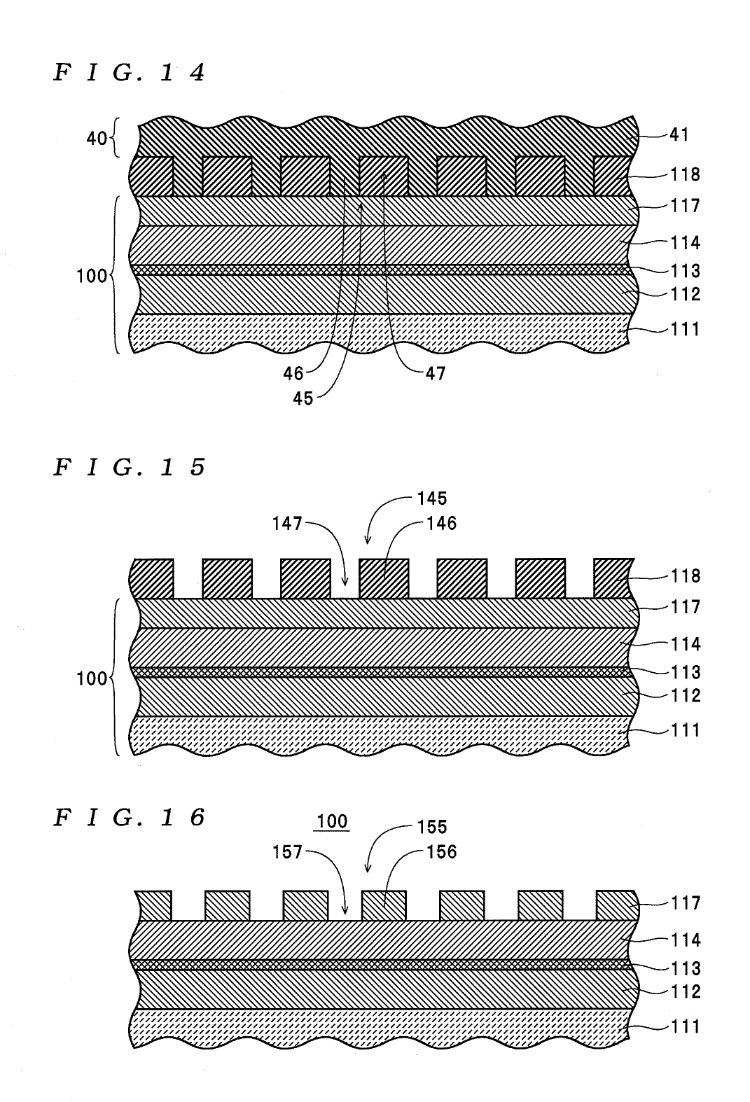

On the other hand, when manufacturing the magnetic disk 110A using the stamper 40, first, a preform 100 (see FIG. 4) for manufacturing the magnetic disk 110A is prepared. As one example, the preform 100 is constructed with the soft magnetic layer 112, the intermediate layer 113, and the magnetic layer 114 formed in the mentioned order on the substrate 111 and also has an A mask layer 117 formed so as to cover the magnetic layer 114. Here, as one example, the A mask layer 117 on the preform 100 is formed of a metal material. Next, a B mask layer 118 (one example of a “mask forming layer”: as one example, a layer of resin material) is formed on the A mask layer 117 of the preform 100. After this, the preform 100 on which the formation of the B mask layer 118 has been completed and the stamper 40 are set in an imprint processing apparatus and an imprint process is commenced. As shown in FIG. 14, by pressing the convexes 46 in the concave/convex pattern 45 of the stamper 40 onto (into) the B mask layer 118, the concave/convex pattern 45 is transferred to the B mask layer 118 on the preform 100.

Next, as shown in FIG. 15, the stamper 40 is separated from the preform 100 (the B mask layer 118). By doing so, a concave/convex pattern 145 (mask pattern) with plural concaves 147 corresponding to the convexes 46 in the concave/convex pattern 45 of the stamper 40 and plural convexes 146 corresponding to the concaves 47 in the concave/convex pattern 45 is formed on the A mask layer 117 of the preform 100. Here, as described above, the concave/convex pattern 45 of the stamper 40 is formed with high precision without unnecessary concaves 47 (defects) being formed. Accordingly, the concave/convex pattern 145 formed corresponding to the concave/convex pattern 45 (i.e., formed by transferring the concave/convex pattern 45) will also be formed with high precision without unnecessary convexes 146 (defects) being formed. Next, the thin B mask layer 118 (hereinafter also referred to as “residue”) remaining on the bottom surfaces of the concaves 147 (i.e., at positions where the convexes 46 of the stamper 40 were pressed in) is removed from above the A mask layer 117 by an oxygen plasma process. Note that the residue is not shown in FIG. 15. When doing so, a slight amount of the B mask layer 118 on the inner side surfaces of the concaves 147 is removed in addition to the residue on the bottom surfaces of the concaves 147. Accordingly, when the residue removing process (oxygen plasma process) has been completed, the open widths of the concaves 147 are slightly wider than when the stamper 40 was separated.

After this, an etching process is carried out using the B mask layer 118 (the convexes 146 of the concave/convex pattern 145) on the A mask layer 117 as a mask. When doing so, as shown in FIG. 16, a concave/convex pattern 155 (mask pattern) with plural convexes 156 corresponding to the convexes 146 in the concave/convex pattern 145 and plural concaves 157 corresponding to the concaves 147 in the concave/convex pattern 145 is formed on the magnetic layer 114. In this case, as described above, the concave/convex pattern 145 is formed with high precision without unnecessary convexes 146 (defects) being formed. Accordingly, the concave/convex pattern 155 formed corresponding to the concave/convex pattern 145 will be formed with high precision without unnecessary convexes 156 (defects) being formed. Note that during the etching process that uses the B mask layer 118 (the concave/convex pattern 145), the A mask layer 117 is slightly etched not only in the thickness direction of the preform 100 but in the plane (i.e., perpendicular to the thickness direction) of the preform 100. Accordingly, in the concave/convex pattern 155 formed on the magnetic layer 114 by the etching process using the B mask layer 118 (the concave/convex pattern 145), the open widths of the concaves 157 become slightly wider than the open widths of the concaves 147 of the concave/convex pattern 145 described above.

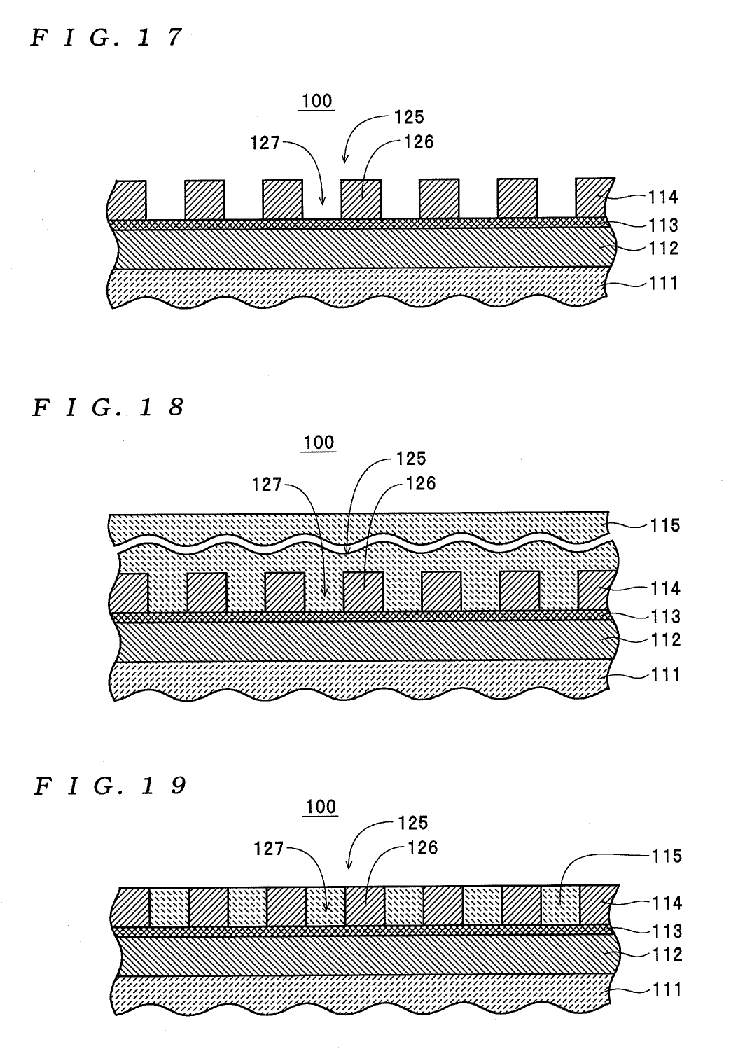

Next, an etching process is carried out using the A mask layer 117 on the magnetic layer 114 (the convexes 156 of the concave/convex pattern 155) as a mask. When doing so, as shown in FIG. 17, a concave/convex pattern 125 with plural convexes 126 corresponding to the convexes 156 of the concave/convex pattern 155 and plural concaves 127 corresponding to the concaves 157 of the concave/convex pattern 155 is formed on the intermediate layer 113. In this case, as described above, the concave/convex pattern 155 is formed with high precision without unnecessary convexes 156 (defects) being formed. Accordingly, the concave/convex pattern 125 formed corresponding to the concave/convex pattern 155 will also be formed with high precision without unnecessary convexes 126 (defects) being formed. Note that during the etching process that uses the A mask layer 117 (the concave/convex pattern 155), the magnetic layer 114 is slightly etched not only in the thickness direction of the preform 100 but in the plane (i.e., perpendicular to the thickness direction) of the preform 100. Accordingly, in the concave/convex pattern 125 formed on the intermediate layer 113 by the etching process using the A mask layer 117 (the concave/convex pattern 155), the open widths of the concaves 127 become slightly wider than the open widths of the concaves 157 of the concave/convex pattern 155 described above.

In this way, when manufacturing the magnetic disk 110A using the stamper 40, the open widths of the concaves tend to become gradually wider during the residue removing process and the etching processes. Putting this another way, the area of the protruding end surfaces of the convexes 126 formed on the intermediate layer 113 of the preform 100 by the series of processes described above tends to become narrower than the area of the protruding end surfaces of the convexes 146 formed on the A mask layer 117 of the preform 100 corresponding to the concaves 47 of the concave/convex pattern 45 of the stamper 40 during the imprinting process. Accordingly, as shown in FIG. 7, in the exposure pattern PA drawn when manufacturing the stamper 40 described above, since it is necessary to make the unexposed regions Ab corresponding to the protruding end surfaces of the convexes 126 in the concave/convex pattern 125 to be formed on the intermediate layer 113 (the rectangular regions shown by the broken lines in FIG. 7) wider in advance than the protruding end surfaces of the convexes 126 (i.e., since it is necessary to make the unexposed regions Ab wider than the protruding end surfaces of the convexes 126 to make the bottom surfaces of the concaves 47 of the stamper 40 wider in advance than the protruding end surfaces of the convexes 126), the exposed regions Aa corresponding to the concaves 127 in the concave/convex pattern 125 are drawn narrower than the concaves 127. For this reason, as described above, the length L2 along the direction of rotation of the exposed regions Aa2 that contact the unexposed regions Ab in the direction of rotation is shorter than the length along the direction of rotation of the concaves 127 that will be finally formed on the intermediate layer 113 corresponding to such exposed regions Aa2.

Next, after the A mask layer 117 (not shown) remaining on the convexes 126 of the concave/convex pattern 125 has been removed, as shown in FIG. 18, a layer of a non-magnetic material 115 is formed so as to cover the concave/convex pattern 125. After this, as shown in FIG. 19, the layer of the non-magnetic material 115 is sufficiently etched until the protruding end surfaces of the convexes 126 of the concave/convex pattern 125 are exposed, thereby smoothing the surface of the preform 100 (i.e., the surface on which the concave/convex pattern 125 has been formed). Next, after a protective layer 116 has been formed on the convexes 126 of the concave/convex pattern 125 and on the non-magnetic material 115 filled inside the concaves 127 in the concave/convex pattern 125, a lubricant is applied onto the surface of the formed protective layer 116. By doing so, as shown in FIG. 2, the magnetic disk 110A is completed. On the magnetic disk 110A, as described above, the concave/convex pattern 125 is formed with high precision without unnecessary convexes 126 (defects) being formed. Accordingly, unlike a magnetic disk (not shown) manufactured using a stamper manufactured using the exposure pattern Pax drawn using the conventional drawing method, it will be possible to sufficiently raise the recording density while avoiding read errors for the servo patterns and the like in spite of the component parts having a reduced length in the radial direction.

In this way, according to the drawing apparatus 1 and the method of drawing a pattern using the drawing apparatus 1, when drawing the exposure pattern PA including positions (in this example, burst pattern regions) where a predetermined one out of plural unexposed regions Ab is surrounded by four exposed regions Aa composed of two exposed regions Aa1 that contact the predetermined unexposed region Ab in the radial direction and two exposed regions Aa2 that contact the predetermined unexposed region Ab in the direction of rotation and where the length L2 along the direction of rotation of at least one (in this example, both) of the two exposed regions Aa2 is shorter than the length L1 along the direction of rotation of at least one (in this example, both) of the two exposed regions Aa1, if the number of times the electron beam EB is emitted onto the regions to become the exposed regions Aa1 is set at N, the length L3 along the radial direction of the regions to become the exposed regions Aa1 is set at a “third length”, the number of times the electron beam EB is emitted onto the regions to become the exposed regions Aa2 is set at M, and the length L4 along the radial direction between the beam center when the electron beam EB is emitted onto the innermost position in the radial direction of a region to become an exposed region Aa2 out of the M times the electron beam EB is emitted and the beam center when the electron beam EB is emitted onto the outermost position in the radial direction of the region to become the exposed region Aa2 is set as the “fourth length”, the electron beam EB is emitted onto the resin layer 12 so that a value produced by dividing the fourth length by (M−1) is lower than a value produced by dividing the third length by (N+1).

Therefore, according to the drawing apparatus 1 and the method of drawing a pattern using the drawing apparatus 1, in the same way as on the regions to become the exposed regions Aa1, it is possible to sufficiently emit the electron beam EB onto regions to become the exposed regions Aa2 where the amount of exposure tends to be insufficient due to the irradiation distance (irradiation time) of the electron beam EB being shorter than in the regions to become the exposed regions Aa1 due to the shorter length along the direction of rotation. By doing so, according to the drawing apparatus 1 and the drawing method for a pattern using the drawing apparatus 1, it is possible to avoid a situation where defects are produced in the concave/convex pattern 15 that is formed by a developing process after the exposure pattern PA has been drawn (defects whereby convexes 16 are formed at positions where concaves 17 should be formed corresponding to the exposed regions Aa) and thereby form the desired concave/convex pattern 15 with high precision. Here, by emitting the electron beam EB onto the resin layer 12 so that the irradiation pitch P3 of the electron beam EB emitted onto the regions to become the exposed regions Aa1 is narrower than the irradiation pitch P2 of the electron beam EB emitted onto the regions to become the exposed regions Aa2, it is possible to sufficiently emit the electron beam EB onto the regions to become the exposed regions Aa1 where there is a tendency for the amount of exposure to be insufficient when the length along the radial direction of the component parts of the exposure pattern PA is shortened, and therefore achieve the effects described above.

Also, according to the method of manufacturing the stamper 40 described above, by drawing the exposure pattern PA on the resin layer 12 according to the drawing method described above and then carrying out the developing process to form the concaves 17 in the exposed regions Aa and thereby form the concave/convex pattern 15 (first concave/convex pattern) on the silicon base plate 11, and transferring the concave/convex pattern 35 (second concave/convex pattern) formed via multiple transfer processes using the concave/convex pattern 15 onto the resin material 41 via an injection molding process to manufacture the stamper 40, it is possible to avoid a situation where a concave/convex pattern 45 is formed with defects on the stamper 40 and thereby manufacture the stamper 40 where the desired concave/convex pattern 45 has been formed with high precision. Therefore, according to the method of manufacturing the stamper 40, by manufacturing the magnetic disk 110A by forming the concave/convex pattern 145 (mask pattern) by carrying out an imprinting process using the manufactured stamper 40, it is possible to form the concave/convex pattern 125 with high precision without defects that may lead to read errors for the servo patterns and the like. Here, by manufacturing the magnetic disk 110A using the stamper 40 manufactured by emitting the electron beam EB onto the resin layer 12 so that when the exposure pattern PA is drawn, the irradiation pitch P3 of the electron beam EB emitted onto regions to become the exposed regions Aa1 is narrower than the irradiation pitch P2 of the electron beam EB emitted onto regions to become the exposed regions Aa2, it is possible to reduce the length along the radial direction of the component parts of the servo patterns and the like and thereby sufficiently raise the recording density.

Also, according to the method of manufacturing the magnetic disk 110A described above, by manufacturing the magnetic disk 110A by carrying out an imprinting process using the stamper 40 manufactured in accordance with the stamper manufacturing method described above to form the concave/convex pattern 145 in the B mask layer 118 on the preform 100 and carrying out an etching process on the preform 100 using the B mask layer 118 in which the concave/convex pattern 145 has been formed (i.e., the convexes 146) as a mask, the magnetic disk 110A will be manufactured with the concave/convex pattern 145 (mask pattern) formed by carrying out an imprinting process using the stamper 40 on which the concave/convex pattern 45 has been formed with high precision, which means that it is possible to manufacture the magnetic disk 110A on which the concave/convex pattern 125 is formed with high precision and without defects that can cause reading errors for the servo patterns and the like. Here, by using the stamper 40 that has been manufactured by emitting the electron beam EB onto the resin layer 12 so that the irradiation pitch P3 of the electron beam EB emitted onto the regions to become the exposed regions Aa1 when drawing the exposure pattern PA is narrower than the irradiation pitch P2 of the electron beam EB emitted onto the regions to become the exposed regions Aa2, it is possible to manufacture the magnetic disk 110A where the length along the radial direction of the component parts of the servo patterns and the like is sufficiently short, which makes it possible to manufacture a magnetic disk 110A which is capable of high-density recording.

Note that although an example where the irradiation pitch P3 is set at 0 nm has been described as one example of a “first average irradiation pitch of the drawing beam that is emitted onto the first region”, it is possible to change the irradiation pitch P3 described above as appropriate within a range where a condition that the irradiation pitch P3 is narrower than “a second average irradiation pitch of the drawing beam emitted onto the second regions (in this example, the irradiation pitch P2=5.6 nm)” is satisfied. When doing so, by setting the irradiation pitch P3 described above wider than 0 nm and narrower than the irradiation pitch P2 (for example, at 1.0 nm), it is possible to set the length along the radial direction of the exposed regions Aa1 longer than the length L3 described above and shorter than the length L3x of the exposed regions Aa1x of the exposure pattern Pax drawn in accordance with the conventional drawing method without causing insufficiencies in exposure. Note that when the electron beam EB is emitted with an irradiation pitch P3 that is wider than 0 nm, the entire range where exposure pattern PA is to be drawn corresponds to “at least part of the substrate”.

Also, although an example has been described where the electron beam EB is emitted with the irradiation pitch P3 (in this example, 0 nm) that is the same in the entire range in the radial direction of the exposed regions Aa1 and the electron beam EB is emitted with the irradiation pitch P2 (in this example, 5.6 nm) that is the same in the entire range in the radial direction of the exposed regions Aa2, if the average irradiation pitch of the electron beam EB on the exposed regions Aa1 (the “first average irradiation pitch”) is narrower than the average irradiation pitch of the electron beam EB on the exposed regions Aa2 (the “second average irradiation pitch”), the number of times the electron beam EB is emitted onto the regions to become the exposed regions Aa1 is set at N, the length L3 along the radial direction of the regions to become the exposed regions Aa1 is set at the third length, the number of times the electron beam EB is emitted onto the regions to become the exposed regions Aa2 is set at M, and the length L4 along the radial direction between the beam center when the electron beam is emitted onto the innermost periphery in the radial direction of the regions to become the exposed regions Aa2 out of the M times the electron beam is emitted and the beam center when the electron beam EB is emitted onto the outermost periphery in the radial direction of the regions to become the exposed regions Aa2 is set at the fourth length, so long as the condition that the value produced by dividing the fourth length by (M−1) is lower than the value produced by dividing the third length by (N+1) is satisfied, it is possible to set the irradiation pitch of the electron beam EB at different pitches in the various parts in the radial direction of the exposed regions Aa1 and/or to set the irradiation pitch of the electron beam EB at different pitches in the various parts in the radial direction of the exposed regions Aa2.

More specifically, as one example, as shown in FIG. 20, it is possible to use a method where the exposure pattern PAa is drawn by emitting the electron beam EB onto the resin layer 12 so that only the average irradiation pitch of the electron beam EB in the center in the radial direction of the exposed regions Aa1 (one example of “first exposed regions”) between unexposed regions Ab that are aligned in the radial direction is narrower than the average irradiation pitch of the electron beam EB in the exposed regions Aa2 and/or a method where the exposure pattern PAa is drawn by emitting the electron beam EB onto the resin layer 12 so that the average irradiation pitch of the electron beam EB in the center in the radial direction of the exposed regions Aa2 (one example of “second exposed regions”) between unexposed regions Ab that are aligned in the direction of rotation is narrower than the average irradiation pitch of the electron beam EB at both ends in the radial direction of the exposed regions Aa2. Here, in the exposure pattern PAa, the length L3a (another example of the “third length”) along the radial direction of the exposed regions Aa1 is slightly longer than the length L3 along the radial direction of the exposed regions Aa1 in the exposure pattern PA described earlier. Note that for the exposure pattern PAa, elements that are the same as when the exposure pattern PA described above is drawn have been assigned the same reference numerals and duplicated description thereof is omitted.

Note that with the drawing method for the exposure pattern PAa, the electron beam EB is emitted so that the length L5c along the radial direction between (i) the virtual extended line along the direction of rotation of the beam center during emission of the electron beam EB on the outermost (or innermost) position in the radial direction of a “first region” to become an exposed region Aa1 out of the multiple emissions of the electron beam EB when drawing the exposure pattern PAa and (ii) the closest beam center that is positioned on the outside (or inside) in the radial direction to the virtual extended line described above out of the beam centers during the multiple emissions of the electron beam EB when drawing the exposure pattern PAa (in this example, the beam center during emission of the electron beam EB at the innermost (or outermost) position in the radial direction of a “second region” to become an exposed region Aa2) is longer than the length L5a (a length corresponding to the irradiation pitch P2 described earlier) along the radial direction between the beam centers during the multiple emissions of the electron beam EB in the second region and/or is longer than the length corresponding to the average irradiation pitch of the electron beam EB on the second region (i.e., so that the length L5a and/or the length corresponding to the average irradiation pitch of the electron beam EB on the second regions is shorter than the length L5c).

Also, in the method of drawing the exposure pattern PAa, the electron beam EB is emitted onto a “third region” to become an exposed region Aa3 that is located between two exposed regions Aa1, Aa1 that are adjacent in the direction of rotation and between two exposed regions Aa2, Aa2 that are adjacent in the radial direction continuously from the first region that is adjacent to the third region in the direction of rotation without stopping the emission of the electron beam EB. Therefore, according to the drawing method for the exposure pattern PAa, the beam center during emission of the electron beam EB at the outermost (or innermost) position in the radial direction of the third region coincides with a virtual extended line along the direction of rotation for the beam center during emission of the electron beam EB on the outermost (or innermost) position in the radial direction of the first region. This means that according to the drawing method for the exposure pattern PAa, the electron beam EB is emitted so that the length L5c along the radial direction between the beam center during emission of the electron beam EB on the outermost (or innermost) position in the radial direction of a third region and the beam center that is closest to such beam center on the outside (or inside) thereof in the radial direction (in this example, the beam center when the electron beam EB is emitted at the innermost (or outermost) position in the radial direction of a second region) is longer than the length L5a along the radial direction between the beam centers during multiple emissions of the electron beam EB in the second region and/or is longer than a length corresponding to an average irradiation pitch of the electron beam EB in the second region (i.e., so that the length L5a and/or a length corresponding to an average irradiation pitch of the electron beam EB on the second region is shorter than the length L5c).

In this case, the present inventors found that there is a tendency for defects to be produced in the pattern due to the amount of irradiation with the electron beam EB tending to be insufficient in the center in the radial direction of the exposed regions where the length along the direction of rotation is short. Accordingly, as shown in FIG. 20, the electron beam EB should preferably be emitted on the resin layer 12 so that the average irradiation pitch of the electron beam EB on at least the center in the radial direction of the exposed regions Aa2 (the second exposed regions) between unexposed regions Ab aligned in the direction of rotation is narrower than the average irradiation pitch of the electron beam on the exposed regions Aa2x when drawing the exposure pattern Pax according to the conventional drawing method. In this way, by making the average irradiation pitch of the electron beam EB on at least the center in the radial direction of the regions to become the exposed regions Aa2 sufficiently narrow, it is possible to reliably emit the electron beam EB sufficiently onto the center in the radial direction of the exposed regions Aa2 that is susceptible to insufficient exposure, which means it is possible to reliably avoid a situation where defects are produced in the concave/convex pattern 15 formed by the developing process.

Next, a method of drawing the exposure pattern PB will be mainly described for the method of manufacturing the stamper 40 used to manufacture the magnetic disk 110B with reference to the drawings. Note that since the method of fabricating the workpiece 10 on which the exposure pattern PB is drawn and the method of manufacturing the magnetic disk 110B using the stamper 40 is the same as the method of fabricating the workpiece 10 and the method of manufacturing the magnetic disk 110A described above, detailed description thereof is omitted.

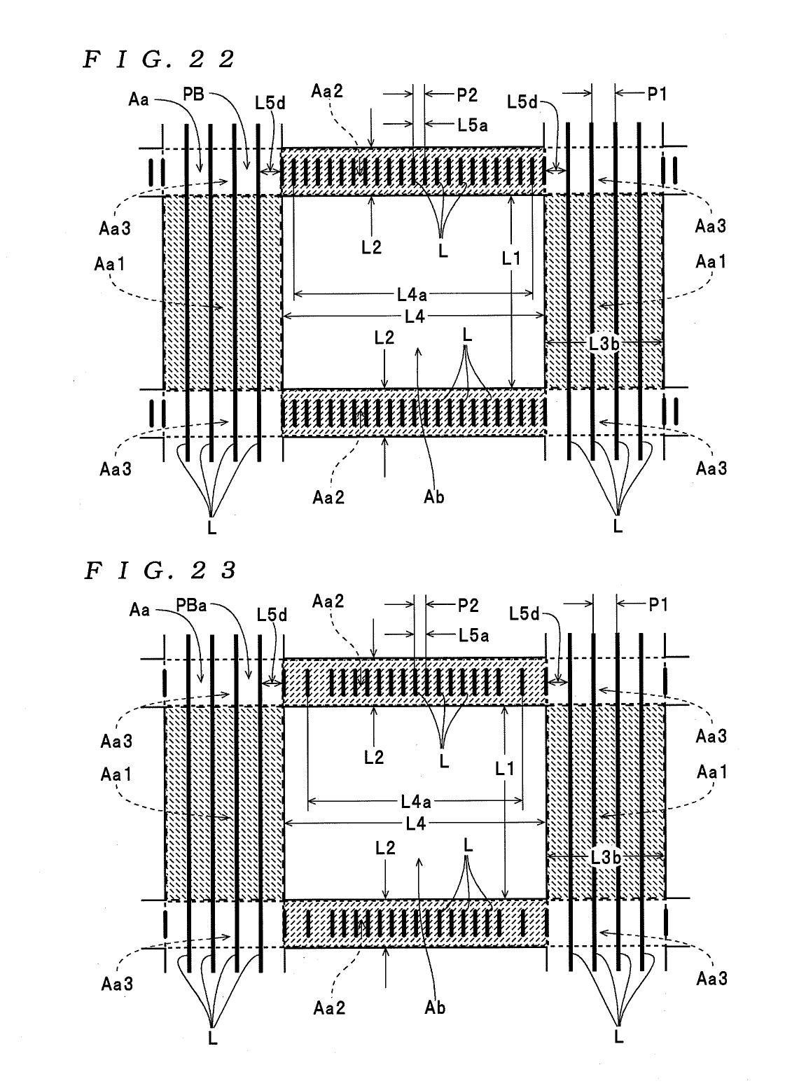

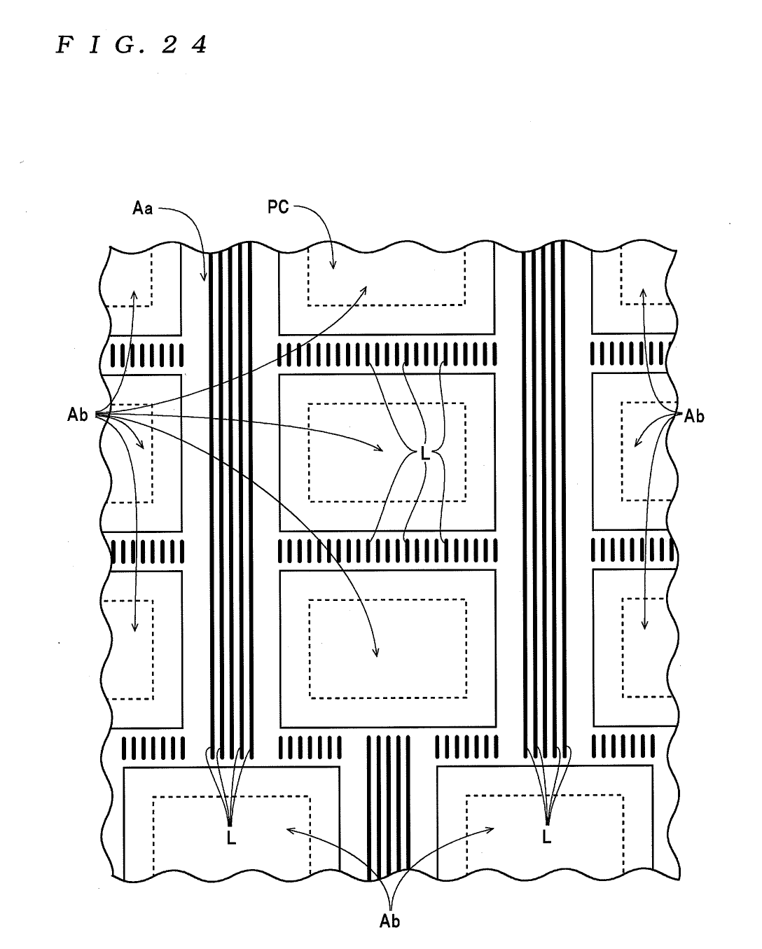

When manufacturing the stamper 40 used to manufacture the magnetic disk 110B, first the exposure pattern PB shown in FIG. 21 is drawn on the resin layer 12 of the workpiece 10. Note that in FIG. 21 and in FIGS. 22 and 23 described later, the paths relatively traced by the beam center of the electron beam EB emitted onto the resin layer 12 when drawing the exposure patterns PB, PBa are shown by the thick lines L. When doing so, the control unit 8 of the drawing apparatus 1 controls the other components in accordance with the drawing procedure data DP for the exposure pattern PB stored in the storage unit 9. Hereinafter, description of the drawing procedure that is the same as for the exposure pattern PA described earlier is omitted and the description will instead focus on characteristics of the drawing procedure for the exposure pattern PB.

More specifically, as shown in FIG. 22, when drawing at a position where a predetermined region out of plural unexposed regions Ab (as one example, the unexposed region Ab in the upper center in FIG. 21) is surrounded by four exposed regions Aa composed of two exposed regions Aa1 (examples of “first exposed regions” for the present invention) that contact such unexposed region Ab in the radial direction (the left-right direction in FIG. 22) and two exposed regions Aa2 (examples of “second exposed regions” for the present invention) that contact such unexposed region Ab in the direction of rotation (the up-down direction in FIG. 22) and where the length L2 along the direction of rotation (a “second length” for the present invention: as one example, 30 nm) of at least one out of the two exposed regions Aa2 (in this example, both regions) is shorter than the length L1 along the direction of rotation (a “first length” for the present invention: as one example, 100 nm) of at least one out of the two exposed regions Aa1 (in this example, both regions), the control unit 8 controls the beam deflecting unit 7 to emit the electron beam EB onto the resin layer 12 so that the average irradiation pitch (a “second average irradiation pitch of the drawing beam emitted onto the second regions”: in this example, irradiation pitch P2) of the electron beam EB emitted onto regions to become the exposed regions Aa2 (a “second region” for the present invention: regions that are diagonally shaded with broken lines from top right in FIG. 22) is narrower than the average irradiation pitch (in this example, the irradiation pitch P1) of the electron beam emitted onto regions to become exposed regions Aa2x (regions that are diagonally shaded with broken lines from top right in FIG. 35) when drawing an exposure pattern Pbx in accordance with the conventional drawing method.

When drawing the exposure pattern PB, the control unit 8 emits the electron beam EB onto the resin layer 12 so that the average irradiation pitch (“second average irradiation pitch”: in this example the irradiation pitch P2) of the electron beam EB emitted onto the regions to become the exposed regions Aa2 (“second regions”: regions that have been diagonally shaded with broken lines from top right in FIG. 22) is narrower than the average irradiation pitch (“first average irradiation pitch”: in this example the irradiation pitch P1) of the electron beam EB emitted onto the regions to become the exposed regions Aa1 (“first regions”: regions that have been diagonally shaded with broken lines from top left in FIG. 22). More specifically, the control unit 8 controls the beam deflecting unit 7 in accordance with the drawing procedure data DP for the exposure pattern PB so that as one example, when the irradiation pitch P1 described above is set at 8.0 nm, the irradiated position in the radial direction of the electron beam EB (i.e., the position on the resin layer 12 that is relatively passed by the beam center of the electron beam EB) is changed with the irradiation pitch P2 described above set at 5.6 nm. Note that in FIGS. 21 and 22, for ease of understanding the drawing method, the difference between the irradiation pitches P1, P2 described above has been exaggerated (by showing irradiation pitch P2 smaller).

Note that in the exposure pattern PB shown in FIGS. 21 and 22, parts of exposed regions Aa that are positioned in the radial direction (in this example, the left-right direction in both drawings) relative to a predetermined one of the unexposed regions Ab (in this example, the upper center unexposed region Ab in FIG. 21) and have a length along the direction of rotation (in this example, the up-down direction in both drawings) that is longer than a length along the direction of rotation (in this example, the length L1) of the predetermined unexposed region Ab (in this example, such “parts of exposed regions Aa” are bordered by a pair of virtual extended lines produced by extending both edges that face each other along the radial direction (i.e., both edges that extend in the left-right direction in the drawings) of the predetermined unexposed region Ab described above) are set as “exposed regions Aa1” that correspond to the “first exposed regions” for the present invention. In other words, a state is shown where exposed regions Aa are positioned so as to be continuous at both ends in the direction of rotation of a “first exposed region”.

Also, in the exposure pattern PB, parts of exposed regions Aa that are positioned in the direction of rotation (in this example, the up-down direction in both drawings) relative to a predetermined one of the unexposed regions Ab and have a length along the radial direction (in this example, the left-right direction in both drawings) that is longer than a length along the radial direction (in this example, the length L4) of the predetermined unexposed region Ab (in this example, such “parts of exposed regions Aa” are bordered by a pair of virtual extended lines produced by extending both edges that face each other along the direction of rotation (i.e., both edges that extend in the up-down direction in the drawings) of the predetermined unexposed region Ab described above) are set as “exposed regions Aa2” that correspond to the “second exposed regions” for the present invention. In other words, a state is shown where exposed regions Aa are positioned so as to be continuous at both ends in the radial direction of a “second exposed region”.

Also, in the drawing procedure data DP for the exposure pattern PB, as shown in FIG. 21, as one example, for the exposed regions Aa (i.e., the exposed regions Aa3: see FIG. 22) that contact the exposed regions Aa1 described above in the direction of rotation (i.e., are continuous with the exposed regions Aa1 in the direction of rotation), the drawing procedure is recorded so that the electron beam EB is emitted with the same irradiation pitch P1 as the irradiation pitch P1 of the electron beam EB in the exposed regions Aa1. Also, for exposed regions Aa at positions that are not shown in FIGS. 6 and 21 (regions aside from the burst pattern regions of the servo pattern regions and/or regions that correspond to track pattern regions or the like), the drawing procedure is recorded so that the electron beam EB is emitted with a predetermined irradiation pitch in accordance with the pattern at such positions.

Here, as described earlier, in the drawing method disclosed by the applicant (the “conventional drawing method”), the electron beam is emitted onto the resin layer so that the value produced by dividing the length L3x by (Nx+1) and the value produced by dividing the length L4x by (Mx−1) are equal. On the other hand, as shown in FIG. 22, according to the drawing method for the exposure pattern PB, if the number of times the electron beam EB is emitted onto a region to become an exposed region Aa1 is set at N (in this example, N=4), the length along the radial direction of the region to become the exposed region Aa1 is set at L3b (the “third length”: as one example, 40.0 nm), the number of times the electron beam EB is emitted onto a region to become an exposed region Aa2 is set at M (in this example, M=23), and the length along the radial direction between the beam center when the electron beam EB is emitted onto the innermost periphery (as one example, the leftmost position in the drawing) in the radial direction of the region to become the exposed region Aa2 out of the M times the electron beam EB is emitted and the beam center when the electron beam EB is emitted onto the outermost periphery (as one example, the rightmost position in the drawing) in the radial direction of the region to become the exposed region Aa2 is set at the length L4 (the “fourth length”: as one example, 123.2 nm), with the drawing method for the exposure pattern PA, the electron beam EB is emitted so that the value (in this example, 5.6) produced by dividing the length L4 by (M−1) is lower than the value (in this example, 8.0) produced by dividing the length L3b by (N+1).

Note that with the drawing method for the exposure pattern PB, even if the emissions where the beam center of the electron beam EB matches the end in the radial direction of the region to become the exposed region Aa2 are not counted in the “number of emissions of the electron beam EB emitted on a region to become a exposed region Aa2”, the condition that “the value produced by dividing the fourth length by (M−1) is lower than the value produced by dividing the third length by (N+1)” will still be satisfied. More specifically, if the number of emissions of the electron beam EB emitted onto the regions to become the exposed regions Aa2 is set at twenty-one, which is two lower than in the example described above, and the length along the radial direction between the beam center when the electron beam EB is emitted onto the innermost periphery in the radial direction of the region to become the exposed region Aa2 out of the twenty-one times the electron beam is emitted and the beam center when the electron beam EB is emitted onto the outermost periphery in the radial direction of the region to become the exposed region Aa2 is set at the length L4a (as one example, 112.0 nm), for the drawing method for the exposure pattern PB, the value (in this example, 5.6) produced by dividing the length L4a by (M−1=20) will be lower than the value (in this example, 8.0) produced by dividing the length L3b by (N+1) described above.

Here, as described earlier, with the exposure pattern PB described above, the length L2 along the direction of rotation of the exposed regions Aa2 is shorter than the length L1 along the direction of rotation of the exposed regions Aa1. This means that when the exposure pattern PB is drawn, during one emission (scan) of the electron beam EB, the distance (that is, irradiation time) on the resin layer 12 for which the electron beam EB is emitted onto the exposed regions Aa2 is shorter than the distance (irradiation time) on the resin layer 12 for which the electron beam EB is emitted onto the exposed regions Aa1. Accordingly, by emitting the electron beam EB with the same irradiation pitch P1 in the exposed regions Aa1, Aa2 according to the conventional drawing method, if the electron beam EB is emitted so that the value produced by dividing the length L3b along the radial direction of a region to become an exposed region Aa1 by a value given by adding one to the number of emissions of the electron beam EB emitted onto the region to become the exposed region Aa1 is equal to the value produced by dividing the length L4 along the radial direction between the beam center during emission of the electron beam EB at the innermost position in the radial direction out of the plural emissions on a region to become an exposed region Aa2 and the beam center during emission of the electron beam EB on the outermost position in the radial direction by a value given by subtracting one from the number of emissions of the electron beam EB on the region to become the exposed region Aa2, there is the risk that the amount of irradiation will be insufficient in the exposed regions Aa2 described above where the distance (irradiation time) on the resin layer 12 irradiated by the electron beam EB is short.

On the other hand, with the drawing method for the exposure pattern PB using the electron beam drawing apparatus 1, as described above, the electron beam EB is emitted onto the exposed regions Aa1, Aa2 so that a value (in this example, 5.6) produced by dividing the length L4 along the radial direction between the beam center during emission of the electron beam EB on the innermost position in the radial direction out of the multiple emissions on a region to become an exposed region Aa2 where the irradiation distance (irradiation time) of the electron beam EB is short and the beam center during emission of the electron beam EB on the outermost position in the radial direction by a value given by subtracting one from the number of emissions of the electron beam EB on the region to become the exposed region Aa2 is lower than a value (in this example, 8.0) produced by dividing the length L3b along the radial direction of a regions to become an exposed region Aa1 where the irradiation distance (irradiation time) of the electron beam EB is long by a value given by adding one to the number of emissions of the electron beam EB emitted onto the region to become the exposed region Aa1, and so that the irradiation pitch P2 of the electron beam EB on the regions to become the exposed regions Aa2 is narrower than the irradiation pitch P1 of the electron beam EB on the regions to become the exposed regions Aa1. Accordingly, the electron beam EB is sufficiently emitted onto the exposed regions Aa2, where the irradiation distance (irradiation time) of the electron beam EB is short, with the same or a higher amount of irradiation as the exposed regions Aa1.

Here, as shown in FIG. 22, with the drawing method for the exposure pattern PB, the electron beam EB is emitted so that the length L5d along the radial direction between (i) a virtual extended line along the direction of rotation of the beam center during emission of the electron beam EB on the outermost (or innermost) position in the radial direction in a “first region” to become an exposed region Aa1 out of the multiple emissions of the electron beam EB when drawing the exposure pattern PB and (ii) the closest beam center that is positioned on the outside (or inside) in the radial direction to the virtual extended line described above out of the beam centers during the multiple emissions of the electron beam EB when drawing the exposure pattern PB (in this example, the beam center during emission of the electron beam EB at the innermost (or outermost) position in the radial direction of a “second region” to become an exposed region Aa2) is longer than the length L5a (a length corresponding to the irradiation pitch P2 described earlier, and in this example, a length corresponding to the average irradiation pitch of the electron beam EB in the second regions) along the radial direction between the beam centers during the multiple emissions of the electron beam EB in the second regions (i.e., so that the length L5a is shorter than the length L5d).

Also according to the drawing method for the exposure pattern PB, the electron beam EB is emitted onto a “third region” to become an exposed region Aa3 that is located between two exposed regions Aa1, Aa1 that are adjacent in the direction of rotation and between two exposed regions Aa2, Aa2 that are adjacent in the radial direction continuously from a first region that is adjacent to the third region in the direction of rotation without stopping the emission of the electron beam EB. Therefore, with the drawing method for the exposure pattern PB, the beam center during emission of the electron beam EB on the outermost (or innermost) position in the radial direction of a third region will coincide with a virtual extended line along the direction of rotation of the beam center during emission of the electron beam EB on the outermost (or innermost) position in the radial direction of a first region. This means that with the drawing method for the exposure pattern PB, the electron beam EB is emitted so that the length L5d along the radial direction between the beam center during emission of the electron beam EB on the outermost (or innermost) position in the radial direction of the third region and the beam center that is closest to such beam center on the outside (or inside) thereof in the radial direction (in this example, the beam center when the electron beam EB is emitted at the innermost (or outermost) position in the radial direction of the second region) is longer than the length L5a along the radial direction between the beam centers during multiple emissions of the electron beam EB in the second region (i.e., so that the length L5a is shorter than the length L5d).

After this, the control unit 8 carries out a process that emits the electron beam EB onto the resin layer 12 along the direction of rotation of the workpiece 10 with a predetermined irradiation pitch multiple times. By doing so, the drawing process for the servo patterns and the data track patterns (the exposure pattern PB) is completed. After this, the stamper 40 for the magnetic disk 110B is manufactured in accordance with the same procedure as in the method of manufacturing the stamper 40 for the magnetic disk 110A described earlier. By doing so, as shown in FIG. 3, the stamper 40 (child stamper) for the magnetic disk 110B is completed. After this, the magnetic disk 110B is manufactured using the stamper 40 and the preform 100 in accordance with the same procedure as the method of manufacturing the magnetic disk 110A described earlier. In this case, on the magnetic disk 110B manufactured using the stamper 40 manufactured by drawing the exposure pattern PB, the concave/convex pattern 125 is formed with high precision without forming unnecessary convexes 126 (defects). Accordingly, unlike a magnetic disk (not shown) manufactured using a stamper manufactured using the exposure pattern Pbx drawn according to the conventional drawing method, a situation where read errors occur for the servo patterns and the like is avoided.

In this way, according to the drawing apparatus 1 and the drawing method for drawing a pattern using the drawing apparatus 1, when drawing the exposure pattern PB including positions (in this example, burst pattern regions) where a predetermined one out of plural unexposed regions Ab is surrounded by four exposed regions Aa composed of two exposed regions Aa1 that contact such unexposed region Ab in the radial direction and two exposed regions Aa2 that contact such unexposed region Ab in the direction of rotation and where the length L2 along the direction of rotation of at least one (in this example, both) of the two exposed regions Aa2 is shorter than the length L1 along the direction of rotation of at least one (in this example, both) of the two exposed regions Aa1, if the number of times the electron beam EB is emitted onto the regions to become the exposed regions Aa1 is set at N, the length L3b along the radial direction of the regions to become the exposed regions Aa1 is set at the “third length”, the number of times the electron beam EB is emitted onto the regions to become the exposed regions Aa2 is set at M, and the length L4 along the radial direction between the beam center when the electron beam EB is emitted onto the innermost periphery in the radial direction of the regions to become the exposed regions Aa2 out of the M times the electron beam is emitted and the beam center when the electron beam EB is emitted onto the outermost periphery in the radial direction of the regions to become the exposed regions Aa2 is set at the “fourth length”, the electron beam EB is emitted onto the resin layer 12 so that the value produced by dividing the fourth length by (M−1) is lower than the value produced by dividing the third length by (N+1). In this case, as one example, the electron beam EB is emitted onto the resin layer 12 so that the irradiation pitch P2 of the electron beam EB emitted onto the regions to become the exposed regions Aa2 is narrower than the irradiation pitch P1 of the electron beam EB emitted onto the regions to become the exposed regions Aa1.

Therefore, according to the drawing apparatus 1 and the drawing method for drawing a pattern using the drawing apparatus 1, in the same way as on the regions to become the exposed regions Aa1, it is possible to sufficiently emit the electron beam EB onto regions to become the exposed regions Aa2 where the amount of exposure tends to be insufficient due to the irradiation distance (irradiation time) of the electron beam EB being shorter than in the regions to become the exposed regions Aa1 due to the shorter length along the direction of rotation. By doing so, according to the drawing apparatus 1 and the drawing method for a pattern using the drawing apparatus 1, it is possible to avoid a situation where defects are produced in the concave/convex pattern 15 that is formed by a developing process after the exposure pattern PB has been drawn (defects whereby convexes 16 are formed at positions where concaves 17 should be formed corresponding to the exposed regions Aa) and thereby form the desired concave/convex pattern 15 with high precision.

Also, according to the method of manufacturing the stamper 40 described above, by drawing the exposure pattern PB on the resin layer 12 according to the drawing method described above and then carrying out the developing process to form the concaves 17 in the exposed regions Aa and thereby form the concave/convex pattern 15 (first concave/convex pattern) on the silicon base plate 11, and transferring the concave/convex pattern 35 (second concave/convex pattern) formed via multiple transfer processes using the concave/convex pattern 15 onto the resin material 41 via an injection molding process to manufacture the stamper 40, it is possible to avoid a situation where a concave/convex pattern 45 is formed with defects on the stamper 40 and thereby manufacture the stamper 40 where the desired concave/convex pattern 45 has been formed with high precision. Therefore, according to the method of manufacturing the stamper 40, by manufacturing the magnetic disk 110B by forming the concave/convex pattern 145 (mask pattern) by carrying out an imprinting process using the manufactured stamper 40, it is possible to form the concave/convex pattern 125 with high precision without defects that may lead to read errors for the servo patterns and the like.

Also, according to the method of manufacturing the magnetic disk 110B described above, by manufacturing the magnetic disk 110B by carrying out an imprinting process using the stamper 40 manufactured in accordance with the stamper manufacturing method described above to form the concave/convex pattern 145 in the B mask layer 118 on the preform 100 and carrying out an etching process on the preform 100 using the B mask layer 118 in which the concave/convex pattern 145 has been formed (i.e., the convexes 146) as a mask, the magnetic disk 110B will be manufactured with the concave/convex pattern 145 (mask pattern) formed by carrying out an imprinting process using the stamper 40 on which the concave/convex pattern 45 has been formed with high precision and without defects, which means that it is possible to manufacture the magnetic disk 110B on which the concave/convex pattern 125 is formed with high precision and no defects that can cause reading errors for the servo patterns and the like.

Note that although an example has been described where the electron beam EB is emitted with the irradiation pitch P1 (in this example, 8.0 nm) that is the same in the entire range in the radial direction of the exposed regions Aa1 and the electron beam EB is emitted with the irradiation pitch P2 (in this example, 5.6 nm) that is the same in the entire range in the radial direction of the exposed regions Aa2, it is possible to set the irradiation pitch of the electron beam EB at different pitches in the various parts in the radial direction of the exposed regions Aa1 and/or to set the irradiation pitch of the electron beam EB at different pitches in the various parts in the radial direction of the exposed regions Aa2. More specifically, as one example, as shown in FIG. 23, it is possible to use a method where the exposure pattern PBa is drawn by emitting the electron beam EB onto the resin layer 12 so that the average irradiation pitch of the electron beam EB in the center in the radial direction of the exposed regions Aa2 (“second exposed regions”) between unexposed regions Ab that are aligned in the direction of rotation is narrower than the average irradiation pitch of the electron beam EB at both ends in the radial direction of the exposed regions Aa2. Note that for the exposure pattern PBa, elements that are the same as when the exposure pattern PB described above is drawn have been assigned the same reference numerals and duplicated description thereof is omitted.

Note that with the drawing method for the exposure pattern PBa, the electron beam EB is emitted so that the length L5d along the radial direction between (i) the virtual extended line along the direction of rotation of the beam center during emission of the electron beam EB on the outermost (or innermost) position in the radial direction of a “first region” to become an exposed region Aa1 out of the multiple emissions of the electron beam EB when drawing the exposure pattern PBa and (ii) the closest beam center that is positioned on the outside (or inside) in the radial direction to the virtual extended line described above out of the beam centers during the multiple emissions of the electron beam EB when drawing the exposure pattern PBa (in this example, the beam center during emission of the electron beam EB at the innermost (or outermost) position in the radial direction of a “second region” to become an exposed region Aa2) is longer than the length L5a (a length corresponding to the irradiation pitch P2 described earlier) along the radial direction between the beam centers during the multiple emissions of the electron beam EB in the second region and/or is longer than the length corresponding to the average irradiation pitch of the electron beam EB on the second region (i.e., so that the length L5a and/or the length corresponding to the average irradiation pitch of the electron beam EB on the second regions is shorter than the length L5d).

Also, in the method of drawing the exposure pattern PBa, the electron beam EB is emitted onto a “third region” to become an exposed region Aa3 that is located between two exposed regions Aa1, Aa1 that are adjacent in the direction of rotation and between two exposed regions Aa2, Aa2 that are adjacent in the radial direction continuously from the first region that is adjacent to the third region in the direction of rotation without stopping the emission of the electron beam EB. Therefore, according to the drawing method for the exposure pattern PBa, the beam center during emission of the electron beam EB at the outermost (or innermost) position in the radial direction of the third region coincides with a virtual extended line along the direction of rotation for the beam center during emission of the electron beam EB on the outermost (or innermost) position in the radial direction of the first region. This means that according to the drawing method for the exposure pattern PBa, the electron beam EB is emitted so that the length L5d along the radial direction between the beam center during emission of the electron beam EB on the outermost (or innermost) position in the radial direction of a third region and the beam center that is closest to such beam center on the outside (or inside) thereof in the radial direction (in this example, the beam center when the electron beam EB is emitted at the innermost (or outermost) position in the radial direction of a second region) is longer than the length L5a along the radial direction between the beam centers during multiple emissions of the electron beam EB in the second region and/or is longer than a length corresponding to an average irradiation pitch of the electron beam EB in the second region (i.e., so that the length L5a and/or a length corresponding to an average irradiation pitch of the electron beam EB on the second region is shorter than the length L5d).

In this case, as described earlier, the present inventors found that there is a tendency for defects to be produced in the pattern due to the amount of irradiation with the electron beam EB tending to be insufficient in the center in the radial direction of the exposed regions where the length along the direction of rotation is short. Accordingly, as shown in FIG. 23, the electron beam EB should preferably be emitted on the resin layer 12 so that the average irradiation pitch of the electron beam EB on at least the center in the radial direction of the exposed regions Aa2 (the second exposed regions) between unexposed regions Ab aligned in the direction of rotation is narrower than the average irradiation pitch of the electron beam on the exposed regions Aa2x when drawing the exposure pattern Pbx according to the conventional drawing method (in this example, narrower than the average irradiation pitch of the electron beam EB emitted onto the exposed regions Aa1 (first exposed regions) between the unexposed regions Ab aligned in the radial direction). In this way, by making the average irradiation pitch of the electron beam EB on at least the center in the radial direction of the regions to become the exposed regions Aa2 sufficiently narrow, it is possible to reliably emit the electron beam EB sufficiently onto the center in the radial direction of the exposed regions Aa2 that is susceptible to insufficient exposure, which means it is possible to reliably avoid a situation where defects are produced in the concave/convex pattern 15 formed by the developing process.

Next, a method of drawing the exposure pattern PC will be mainly described for the method of manufacturing the stamper 40 used to manufacture the magnetic disk 110C with reference to the drawings. Note that since the method of fabricating the workpiece 10 on which the exposure pattern PC is drawn and the method of manufacturing the magnetic disk 110C using the stamper 40 is the same as the method of fabricating the workpiece 10 and the method of manufacturing the magnetic disk 110A described above, detailed description thereof is omitted.

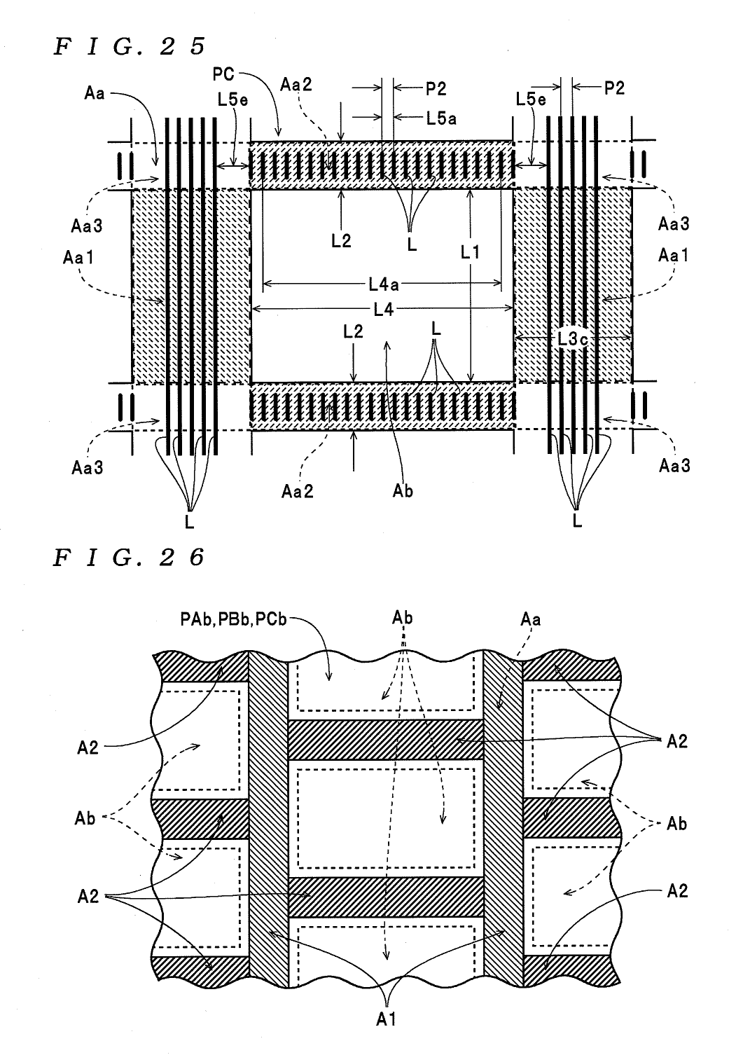

When manufacturing the stamper 40 used to manufacture the magnetic disk 110C, first the exposure pattern PC shown in FIG. 24 is drawn on the resin layer 12 of the workpiece 10. Note that in FIG. 24 and in FIG. 25 described later, the paths relatively traced by the beam center of the electron beam EB emitted onto the resin layer 12 when drawing the exposure pattern PC are shown by the thick lines L. When doing so, the control unit 8 of the drawing apparatus 1 controls the other components in accordance with the drawing procedure data DP for the exposure pattern PC stored in the storage unit 9. Hereinafter, description of the drawing procedure that is the same as for the exposure patterns PA, PB described earlier is omitted and the description will instead focus on characteristics of the drawing procedure for the exposure pattern PC.

More specifically, as shown in FIG. 25, when drawing at a position where a predetermined region out of plural unexposed regions Ab (as one example, the unexposed region Ab in the upper center in FIG. 24) is surrounded by four exposed regions Aa composed of two exposed regions Aa1 (examples of “first exposed regions” for the present invention) that contact such unexposed region Ab in the radial direction (the left-right direction in FIG. 25) and two exposed regions Aa2 (examples of “second exposed regions” for the present invention) that contact such unexposed region Ab in the direction of rotation (the up-down direction in FIG. 25) and where the length L2 along the direction of rotation (a “second length” for the present invention: as one example, 30 nm) of at least one out of the two exposed regions Aa2 (in this example, both regions) is shorter than the length L1 along the direction of rotation (a “first length” for the present invention: as one example, 100 nm) of at least one out of the two exposed regions Aa1 (in this example, both regions), the control unit 8 controls the beam deflecting unit 7 to emit the electron beam EB onto the resin layer 12 so that the average irradiation pitch (a “second average irradiation pitch of the drawing beam emitted onto the second regions”: in this example, irradiation pitch P2) of the electron beam EB emitted onto regions to become the exposed regions Aa2 (a “second region” for the present invention: regions that are diagonally shaded with broken lines from top right in FIG. 25) is narrower than the average irradiation pitch (in this example, the irradiation pitch P1) of the electron beam emitted onto regions to become exposed regions Aa2x (regions that are diagonally shaded with broken lines from top right in FIG. 34) when drawing an exposure pattern Pax, for example, in accordance with the conventional drawing method.

Also, when drawing the exposure pattern PC, unlike when the exposure patterns PA, PB described earlier are drawn, the control unit 8 emits the electron beam EB onto the resin layer 12 so that the average irradiation pitch of the electron beam EB on the regions to become the exposed regions Aa1 (“first regions”: the regions that are diagonally shaded with broken lines from top left in FIG. 25) is equal to the average irradiation pitch of the electron beam EB on the regions to become the exposed regions Aa2 (“second regions”: the regions that are diagonally shaded with broken lines from top right in FIG. 25) (as one example, so that both pitches are the same irradiation pitch P2 (5.6 nm)).

Note that in the exposure pattern PC shown in FIGS. 24 and 25, parts of exposed regions Aa that are positioned in the radial direction (in this example, the left-right direction in both drawings) relative to a predetermined one of the unexposed regions Ab (in this example, the upper center unexposed region Ab in FIG. 24) and have a length along the direction of rotation (in this example, the up-down direction in both drawings) that is longer than a length along the direction of rotation (in this example, the length L1) of the predetermined unexposed region Ab (in this example, such “parts of exposed regions Aa” are bordered by a pair of virtual extended lines produced by extending both edges that face each other along the radial direction (i.e., both edges that extend in the left-right direction in the drawings) of the predetermined unexposed region Ab described above) are set as “exposed regions Aa1” that correspond to the “first exposed regions” for the present invention. In other words, a state is shown where exposed regions Aa are positioned so as to be continuous at both ends in the direction of rotation of a “first exposed region”.

Also, in the exposure pattern PC, parts of exposed regions Aa that are positioned in the direction of rotation (in this example, the up-down direction in both drawings) relative to a predetermined one of the unexposed regions Ab and have a length along the radial direction (in this example, the left-right direction in both drawings) that is longer than a length along the radial direction (in this example, the length L4) of the predetermined unexposed region Ab (in this example, such “parts of exposed regions Aa” are bordered by a pair of virtual extended lines produced by extending both edges that face each other along the direction of rotation (i.e., both edges that extend in the up-down direction in the drawings) of the predetermined unexposed region Ab described above) are set as “exposed regions Aa2” that correspond to the “second exposed regions” for the present invention. In other words, a state is shown where exposed regions Aa are positioned so as to be continuous at both ends in the radial direction of a “second exposed region”.

Also, in the drawing procedure data DP for the exposure pattern PC, as shown in FIG. 24, as one example, for the exposed regions Aa (i.e., the exposed regions Aa3: see FIG. 25) that contact the exposed regions Aa1 described above in the direction of rotation (i.e., are continuous with the exposed regions Aa1 in the direction of rotation), the drawing procedure is recorded so that the electron beam EB is emitted with the same irradiation pitch P2 as the irradiation pitch P2 of the electron beam EB in the exposed regions Aa1. Also, for exposed regions Aa at positions that are not shown in FIGS. 6 and 24 (regions aside from the burst pattern regions of the servo pattern regions and/or regions that correspond to track pattern regions or the like), the drawing procedure is recorded so that the electron beam EB is emitted with a predetermined irradiation pitch in accordance with the pattern at such positions.

Here, as described earlier, in the drawing method disclosed by the applicant (the “conventional drawing method”), the electron beam is emitted onto the resin layer so that the value produced by dividing the length L3x by (Nx+1) and the value produced by dividing the length L4x by (Mx−1) are equal. On the other hand, as shown in FIG. 25, according to the drawing method for the exposure pattern PC, if the number of times the electron beam EB is emitted onto a region to become an exposed region Aa1 is set at N (in this example, N=5), the length along the radial direction of the region to become the exposed region Aa1 is set at L3c (the “third length”: as one example, 48.0 nm), the number of times the electron beam EB is emitted onto a region to become an exposed region Aa2 is set at M (in this example, M=23), and the length along the radial direction between the beam center when the electron beam EB is emitted onto the innermost periphery (as one example, the leftmost position in the drawing) in the radial direction of the region to become the exposed region Aa2 out of the M times the electron beam EB is emitted and the beam center when the electron beam EB is emitted onto the outermost periphery (as one example, the rightmost position in the drawing) in the radial direction of the region to become the exposed region Aa2 is set at the length L4 (the “fourth length”: as one example, 123.2 nm), with the drawing method for the exposure pattern PA, the electron beam EB is emitted so that the value (in this example, 5.6) produced by dividing the length L4 by (M−1) is lower than the value (in this example, 8.0) produced by dividing the length L3c by (N+1).

Note that with the drawing method for the exposure pattern PC, even if the emissions where the beam center of the electron beam EB matches the end in the radial direction of the region to become the exposed region Aa2 are not counted in the “number of emissions of the electron beam EB emitted on a region to become a exposed region Aa2”, the condition that “the value produced by dividing the fourth length by (M−1) is lower than the value produced by dividing the third length by (N+1)” will still be satisfied.

More specifically, if the number of emissions of the electron beam EB emitted onto the regions to become the exposed regions Aa2 is set at twenty-one, which is two lower than in the example described above, and the length along the radial direction between the beam center when the electron beam EB is emitted onto the innermost periphery in the radial direction of the region to become the exposed region Aa2 out of the twenty-one times the electron beam is emitted and the beam center when the electron beam EB is emitted onto the outermost periphery in the radial direction of the region to become the exposed region Aa2 is set at the length L4a (as one example, 112.0 nm), for the drawing method for the exposure pattern PC, the value (in this example, 5.6) produced by dividing the length L4a by (M−1=20) will be lower than the value (in this example, 8.0) produced by dividing the length L3c by (N+1) described above.

Here, as described earlier, with the exposure pattern PC described above, the length L2 along the direction of rotation of the exposed regions Aa2 is shorter than the length L1 along the direction of rotation of the exposed regions Aa1. This means that when the exposure pattern PC is drawn, during one emission (scan) of the electron beam EB, the distance (that is, irradiation time) on the resin layer 12 for which the electron beam EB is emitted onto the exposed regions Aa2 is shorter than the distance (irradiation time) on the resin layer 12 for which the electron beam EB is emitted onto the exposed regions Aa1. Accordingly, if the electron beam EB is emitted according to the conventional drawing method so that the value produced by dividing the length L3c along the radial direction of a region to become an exposed region Aa1 by a value given by adding one to the number of emissions of the electron beam EB emitted onto the region to become the exposed region Aa1 is equal to the value produced by dividing the length L4 along the radial direction between the beam center during emission of the electron beam EB at the innermost position in the radial direction out of the plural emissions on a region to become an exposed region Aa2 and the beam center during emission of the electron beam EB on the outermost position in the radial direction by a value given by subtracting one from the number of emissions of the electron beam EB on the region to become the exposed region Aa2, there is the risk that the amount of irradiation will be insufficient in the exposed regions Aa2 described above where the distance (irradiation time) on the resin layer 12 irradiated by the electron beam EB is short.

On the other hand, with the drawing method for the exposure pattern PC using the electron beam drawing apparatus 1, as described above, the electron beam EB is emitted onto the exposed regions Aa1, Aa2 so that a value (in this example, 5.6) produced by dividing the length L4 along the radial direction between the beam center during emission of the electron beam EB on the innermost position in the radial direction out of the multiple emissions on a region to become an exposed region Aa2 where the irradiation distance (irradiation time) of the electron beam EB is short and the beam center during emission of the electron beam EB on the outermost position in the radial direction by a value given by subtracting one from the number of emissions of the electron beam EB on the region to become the exposed region Aa2 is lower than a value (in this example, 8.0) produced by dividing the length L3c along the radial direction of a regions to become an exposed region Aa1 where the irradiation distance (irradiation time) of the electron beam EB is long by a value given by adding one to the number of emissions of the electron beam EB emitted onto the region to become the exposed region Aa1. Accordingly, the electron beam EB is sufficiently emitted onto the exposed regions Aa2, where the irradiation distance (irradiation time) of the electron beam EB is short, with the same or a higher amount of irradiation as the exposed regions Aa1.

Here, as shown in FIG. 25, with the drawing method for the exposure pattern PC, the electron beam EB is emitted so that the length L5e along the radial direction between (i) a virtual extended line along the direction of rotation of the beam center during emission of the electron beam EB on the outermost (or innermost) position in the radial direction in a “first region” to become an exposed region Aa1 out of the multiple emissions of the electron beam EB when drawing the exposure pattern PC and (ii) the closest beam center that is positioned on the outside (or inside) in the radial direction to the virtual extended line described above out of the beam centers during the multiple emissions of the electron beam EB when drawing the exposure pattern PC (in this example, the beam center during emission of the electron beam EB at the innermost (or outermost) position in the radial direction of a “second region” to become an exposed region Aa2) is longer than the length L5a (a length corresponding to the irradiation pitch P2 described earlier, and in this example, a length corresponding to the average irradiation pitch of the electron beam EB in the second regions) along the radial direction between the beam centers during the multiple emissions of the electron beam EB in the second regions (i.e., so that the length L5a is shorter than the length L5e).

Also according to the drawing method for the exposure pattern PC, the electron beam EB is emitted onto a “third region” to become an exposed region Aa3 that is located between two exposed regions Aa1, Aa1 that are adjacent in the direction of rotation and between two exposed regions Aa2, Aa2 that are adjacent in the radial direction continuously from a first region that is adjacent to the third region in the direction of rotation without stopping the emission of the electron beam EB. Therefore, with the drawing method for the exposure pattern PC, the beam center during emission of the electron beam EB on the outermost (or innermost) position in the radial direction of a third region will coincide with a virtual extended line along the direction of rotation of the beam center during emission of the electron beam EB on the outermost (or innermost) position in the radial direction of a first region. This means that with the drawing method for the exposure pattern PC, the electron beam EB is emitted so that the length L5e along the radial direction between the beam center during emission of the electron beam EB on the outermost (or innermost) position in the radial direction of the third region and the beam center that is closest to such beam center on the outside (or inside) thereof in the radial direction (in this example, the beam center when the electron beam EB is emitted at the innermost (or outermost) position in the radial direction of the second region) is longer than the length L5a along the radial direction between the beam centers during multiple emissions of the electron beam EB in the second region (i.e., so that the length L5a is shorter than the length L5e).

After this, the control unit 8 carries out a process that emits the electron beam EB onto the resin layer 12 along the direction of rotation of the workpiece 10 with a predetermined irradiation pitch multiple times. By doing so, the drawing process for the servo patterns and the data track patterns (the exposure pattern PC) is completed. After this, the stamper 40 for the magnetic disk 110C is manufactured in accordance with the same procedure as in the method of manufacturing the stamper 40 for the magnetic disks 110A, 110B described earlier. By doing so, as shown in FIG. 3, the stamper 40 (child stamper) for the magnetic disk 110C is completed. Next, the magnetic disk 110C is manufactured using the stamper 40 and the preform 100 in accordance with the same procedure as the method of manufacturing the magnetic disks 110A, 110B described earlier. In this case, on the magnetic disk 110C manufactured using the stamper 40 manufactured by drawing the exposure pattern PC, the concave/convex pattern 125 is formed with high precision without forming unnecessary convexes 126 (defects). Accordingly, unlike a magnetic disk (not shown) manufactured using a stamper manufactured using the exposure pattern Pax drawn according to the conventional drawing method, a situation where read errors occur for the servo patterns and the like is avoided.

In this way, according to the drawing apparatus 1 and the drawing method for drawing a pattern using the drawing apparatus 1, when drawing the exposure pattern PC including positions (in this example, burst pattern regions) where a predetermined one out of plural unexposed regions Ab is surrounded by four exposed regions Aa composed of two exposed regions Aa1 that contact such unexposed region Ab in the radial direction and two exposed regions Aa2 that contact such unexposed region Ab in the direction of rotation and where the length L2 along the direction of rotation of at least one (in this example, both) of the two exposed regions Aa2 is shorter than the length L1 along the direction of rotation of at least one (in this example, both) of the two exposed regions Aa1, if the number of times the electron beam EB is emitted onto the regions to become the exposed regions Aa1 is set at N, the length L3c along the radial direction of the regions to become the exposed regions Aa1 is set at the “third length”, the number of times the electron beam EB is emitted onto the regions to become the exposed regions Aa2 is set at M, and the length L4 along the radial direction between the beam center when the electron beam EB is emitted onto the innermost periphery in the radial direction of the regions to become the exposed regions Aa2 out of the M times the electron beam is emitted and the beam center when the electron beam EB is emitted onto the outermost periphery in the radial direction of the regions to become the exposed regions Aa2 is set at the “fourth length”, the electron beam EB is emitted onto the resin layer 12 so that the value produced by dividing the fourth length by (M−1) is lower than the value produced by dividing the third length by (N+1). In this case, as one example, the electron beam EB is emitted onto the resin layer 12 so that the irradiation pitch P2 of the electron beam EB emitted onto the regions to become the exposed regions Aa2 is narrower than the irradiation pitch P1 of the electron beam EB emitted onto the regions to become the exposed regions Aa1. Here, as one example, the electron beam EB is emitted onto the resin layer 12 so that the irradiation pitch of the electron beam EB emitted onto the regions to become the exposed regions Aa1 and the irradiation pitch of the electron beam EB emitted onto the regions to become the exposed regions Aa2 are both the same irradiation pitch P2.

Therefore, according to the drawing apparatus 1 and the drawing method for drawing a pattern using the drawing apparatus 1, in the same way as on the regions to become the exposed regions Aa1, it is possible to sufficiently emit the electron beam EB onto regions to become the exposed regions Aa2 where the amount of exposure tends to be insufficient due to the irradiation distance (irradiation time) of the electron beam EB being shorter than in the regions to become the exposed regions Aa1 due to the shorter length along the direction of rotation. By doing so, according to the drawing apparatus 1 and the drawing method for a pattern using the drawing apparatus 1, it is possible to avoid a situation where defects are produced in the concave/convex pattern 15 that is formed by a developing process after the exposure pattern PC has been drawn (defects whereby convexes 16 are formed at positions where concaves 17 should be formed corresponding to the exposed regions Aa) and thereby form the desired concave/convex pattern 15 with high precision.

Also, according to the method of manufacturing the stamper 40 described above, by drawing the exposure pattern PC on the resin layer 12 according to the drawing method described above and then carrying out the developing process to form the concaves 17 in the exposed regions Aa and thereby form the concave/convex pattern 15 (first concave/convex pattern) on the silicon base plate 11, and transferring the concave/convex pattern 35 (second concave/convex pattern) formed via multiple transfer processes using the concave/convex pattern 15 onto the resin material 41 via an injection molding process to manufacture the stamper 40, it is possible to avoid a situation where a concave/convex pattern 45 is formed with defects on the stamper 40 and thereby manufacture the stamper 40 where the desired concave/convex pattern 45 has been formed with high precision. Therefore, according to the method of manufacturing the stamper 40, by manufacturing the magnetic disk 110C by forming the concave/convex pattern 145 (mask pattern) by carrying out an imprinting process using the manufactured stamper 40, it is possible to form the concave/convex pattern 125 with high precision without defects that may lead to read errors for the servo patterns and the like.

Also, according to the method of manufacturing the magnetic disk 110C described above, by manufacturing the magnetic disk 110C by carrying out an imprinting process using the stamper 40 manufactured in accordance with the stamper manufacturing method described above to form the concave/convex pattern 145 in the B mask layer 118 on the preform 100 and carrying out an etching process on the preform 100 using the B mask layer 118 in which the concave/convex pattern 145 has been formed (i.e., the convexes 146) as a mask, the magnetic disk 110C will be manufactured with the concave/convex pattern 145 (mask pattern) formed by carrying out an imprinting process using the stamper 40 on which the concave/convex pattern 45 has been formed with high precision and without defects, which means that it is possible to manufacture the magnetic disk 110C on which the concave/convex pattern 125 is formed with high precision and no defects that can cause reading errors for the servo patterns and the like.

Note that although examples have been described where the exposure patterns PA, PAa, PB, PBa, and PC including positions in which plural unexposed regions Ab are orderly aligned in both the direction of rotation and the radial direction of the workpiece 10 are drawn, the “patterns” to be drawn are not limited to such. For example, as shown in FIG. 26, it is possible to realize a drawing method that is the same as the “drawing method” described above when drawing exposure patterns PAb, PBb, PCb including positions in which plural unexposed regions Ab are orderly aligned in the direction of rotation of the workpiece 10 (the up-down direction in FIG. 26) but the unexposed regions Ab are present at alternating positions in the radial direction (the left-right direction in FIG. 26). In this case, in FIGS. 26 to 32, ranges in which the beam center relatively moves when the electron beam EB is emitted with “an average irradiation pitch of the drawing beam emitted onto the first region” have been diagonally shaded from top left as regions A1, and ranges in which the beam center relatively moves when the electron beam EB is emitted with “an average irradiation pitch of the electron beam emitted onto the second region” have been diagonally shaded from top right as regions A2. Accordingly, when the electron beam EB is emitted onto the regions A1, A2 described above, regions that are slightly wider than the regions A1, A2 are the exposed regions Aa, and the unexposed regions Ab are formed as shown by the broken lines in the drawings.

Also, the exposure patterns PAb to PAh, PBb to PBh, PCb to PCh shown in FIGS. 26 to 32 are all drawn so that the condition that “if the number of times the electron beam EB is emitted onto a region to become an exposed regions Aa1 is set at N, the length along the radial direction of the region to become the exposed region Aa1 is set at the third length, the number of times the electron beam EB is emitted onto a region to become an exposed region Aa2 is set at M, and the length along the radial direction between the beam center when the electron beam is emitted onto the innermost periphery in the radial direction of the region to become the exposed region Aa2 out of the M times the electron beam is emitted and the beam center when the electron beam EB is emitted onto the outermost periphery in the radial direction of the region to become the exposed region Aa2 is set at the fourth length, the electron beam EB is emitted so that the value produced by dividing the fourth length by (M−1) is lower than the value produced by dividing the third length by (N+1)” is satisfied.

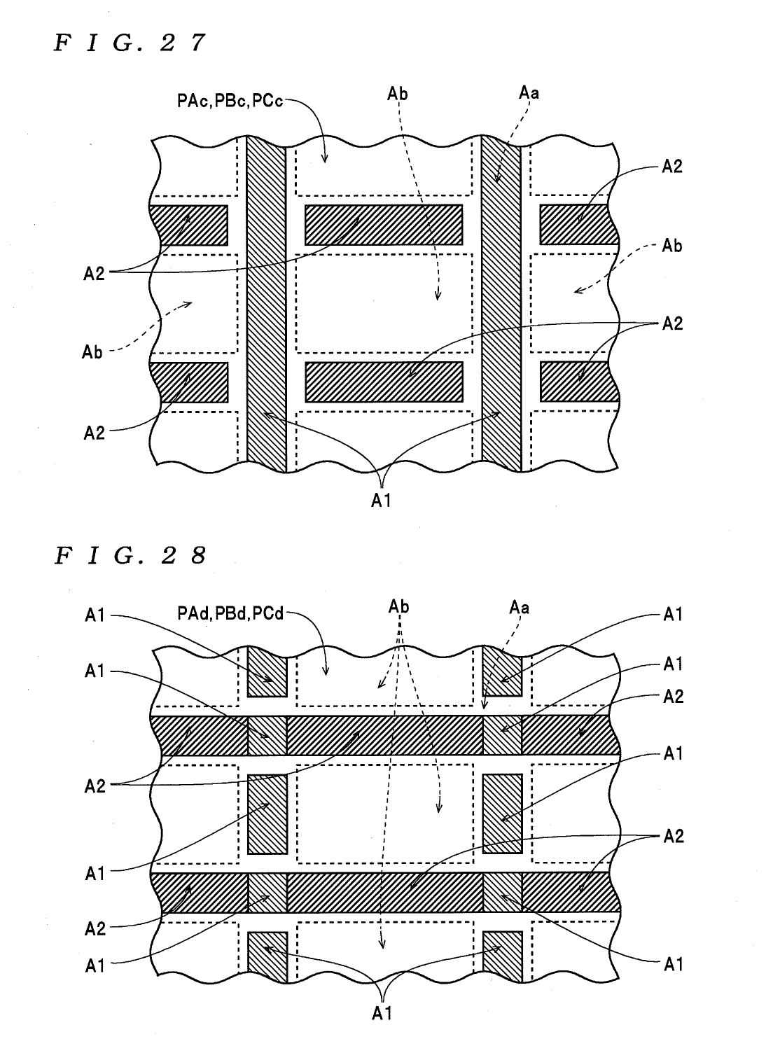

On the other hand, in the exposure patterns PA, PAa, PAb, PB, PBa, PBb, PC, PCb described above, the electron beam EB emitted onto the regions to become the “first exposed regions” and the electron beam EB emitted onto the regions to become the “second exposed regions” combine so that the amount of exposure at the four corners of the rectangular unexposed regions Ab is excessive. Due to this, there is the risk that the corner portions of the rectangular unexposed regions Ab will be rounded. Accordingly, when rounding of the corners of the rectangular unexposed regions Ab would be problematic, to avoid having an excessive exposure in the corners in the rectangular unexposed regions Ab, it is possible to draw the exposure patterns PAc to PAh, PBc to PBh, PCc to PCh by emitting the electron beam EB onto the regions A1, A2 defined as shown in FIGS. 27 to 32. In this way, by emitting the electron beam EB in the periphery of the corners of the regions to become the unexposed regions Ab so that the regions A1, A2 are slightly separated, it is possible to sufficiently expose the regions to become the exposed regions and avoid excessive exposure at the corners of the unexposed regions Ab. By doing so, when a positive resist is used as the resin layer, it is possible to avoid a situation where corners of the convexes formed by the developing process are rounded, and when a negative resist is used as the resin layer, it is possible to avoid a situation where corners of the concaves formed by the developing process are rounded.

In addition, although the exposure patterns PA, PAa to PAh, PB, PBa to PBh, PC, PCb to PCh that correspond to the burst patterns inside the servo pattern regions of the magnetic disk have been given as examples, the “patterns” to be drawn include not only patterns that correspond to burst patterns but also patterns (not shown) that correspond to the data track patterns of a patterned medium where plural convexes that construct data recording tracks are formed so as to be physically separated via concaves not only in the radial direction but also in the direction of rotation. The “drawing beam” is also not limited to the electron beam EB described earlier and it is also possible to use various types of charged particle beam, such as an ion beam, or light (such as a laser beam) of various wavelengths. When doing so, the “resin layer” may be formed of a resin material that is sensitive to the drawing beam in use. Also, although an example has been described where a positive resist is used as the “resin layer”, it is also possible to use a method where the exposure patterns PA, PB, PC, and the like are drawn on a resin layer formed using a negative resist. In this case, when the exposure patterns PA, PB, PC, and the like are drawn on a layer formed using a negative resist, during the developing process, the regions exposed to the electron beam EB will remain on the silicon base plate 11. Accordingly, when a magnetic disk with the same concave/convex pattern 125 as the magnetic disks 110A, 110B, 110C described above is manufactured, a resin stamper (not shown) manufactured by an injection molding process with the stamper 20 or a metal stamper corresponding to the stamper 40 as an original, or the stamper 30 described above may be used as a stamper for the imprinting process.

In addition, the stamper manufactured using the pattern drawn in accordance with the “drawing method” described above includes not only a stamper for manufacturing a magnetic disk for perpendicular recording such as the magnetic disks 110A, 110B, 110C but also a stamper for manufacturing a magnetic disk for longitudinal recording (another example of an “information recording medium”). In addition, it is also possible to apply the “drawing method” described above when manufacturing a stamper used when manufacturing not only a magnetic disk but also an optical disc (an optical recording medium: yet another example of an “information recording medium”). A concave/convex pattern formed using a pattern drawn in accordance with the “drawing method” described above is not limited to being used on a stamper for manufacturing an information medium such as the magnetic disks 110A, 110B, 110C or the like and may also be used when forming a concave/convex pattern used for example when manufacturing a semiconductor element.

What is claimed is:

1. A drawing method operable when rotating a substrate that has a resin layer formed on a surface thereof and emitting a drawing beam onto the resin layer to draw a pattern composed of plural exposed regions and plural unexposed regions on the resin layer, to carry out a process that emits the drawing beam onto the resin layer along a direction of rotation of the substrate multiple times and to change an irradiated position of the drawing beam in a radial direction of the substrate with a predetermined irradiation pitch in at least part of the substrate during the process,
wherein when drawing the pattern that includes a position where a predetermined one out of the plural unexposed regions is surrounded by four exposed regions composed of two first exposed regions that contact the predetermined unexposed region in the radial direction and two second exposed regions that contact the predetermined unexposed region in the direction of rotation and where a second length along the direction of rotation of at least one of the two second exposed regions is shorter than a first length along the direction of rotation of at least one of the two first exposed regions, the drawing beam is emitted onto the resin layer so that if
a number of times the drawing beam is emitted onto first regions to become the at least one first exposed region is set at N (where N is a natural number that is at least two),
a length along the radial direction of the first regions is set at a third length,
a number of times the drawing beam is emitted onto second regions to become the at least one second exposed region is set at M (where M is a natural number that is at least two), and
a length along the radial direction between a beam center when the drawing beam is emitted onto an innermost periphery in the radial direction of the second regions out of the M times the drawing beam is emitted and a beam center when the drawing beam is emitted onto an outermost periphery in the radial direction of the second regions out of the M times the drawing beam is emitted is set at a fourth length,
a value produced by dividing the fourth length by (M−1) is lower than a value produced by dividing the third length by (N+1).

2. The drawing method according to claim 1,
wherein when drawing the pattern that includes the position where the predetermined unexposed region is surrounded by the four exposed regions and where the second length of the at least one second exposed regions is shorter than the first length of the at least one first exposed regions, the drawing beam is emitted onto the resin layer so that a first average irradiation pitch of the drawing beam emitted onto the first regions is narrower than a second average irradiation pitch of the drawing beam emitted onto the second regions.

3. The drawing method according to claim 1,
wherein when drawing the pattern that includes the position where the predetermined unexposed region is surrounded by the four exposed regions and where the second length of the at least one second exposed regions is shorter than the first length of the at least one first exposed regions, the drawing beam is emitted onto the resin layer so that a second average irradiation pitch of the drawing beam emitted onto the second regions is narrower than a first average irradiation pitch of the drawing beam emitted onto the first regions.

4. The drawing method according to claim 3,
wherein the drawing beam is emitted onto the resin layer so that the irradiation pitch of the drawing beam in a center in the radial direction of the second regions is narrower than the first average irradiation pitch.

5. A stamper manufacturing method comprising:
drawing the pattern on the resin layer in accordance with the drawing method according to claim 1;
carrying out a developing process to form concaves in one of the exposed regions and the unexposed regions and thereby form a first concave/convex pattern on the substrate;
transferring one of the first concave/convex pattern and a second concave/convex pattern formed using the first concave/convex pattern onto a stamper forming member in accordance with a predetermined procedure to manufacture a stamper.

6. An information recording medium manufacturing method comprising:
carrying out an imprinting process using the stamper manufactured in accordance with the stamper manufacturing method according to claim 5 to form a mask concave/convex pattern in a mask forming layer on a preform for manufacturing an information recording medium; and
carrying out an etching process on the preform using the mask forming layer in which the mask concave/convex pattern has been formed as a mask to manufacture an information recording medium.

7. A drawing apparatus comprising:
a rotating mechanism that rotates a substrate which has a resin layer formed on a surface thereof;
a beam emitting unit that emits a drawing beam onto the resin layer;
an irradiated position changing unit that changes an irradiated position of the drawing beam in a radial direction of the substrate; and
a control unit operable when drawing a pattern composed of plural exposed regions and plural unexposed regions on the resin layer, to control the rotating mechanism to rotate the substrate, to control the beam emitting unit to carry out a process that emits the drawing beam onto the resin layer along a direction of rotation of the substrate multiple times, and to control the irradiated position changing unit during the process to change the irradiated position with a predetermined irradiation pitch in at least part of the substrate,
wherein the control unit is operable when drawing the pattern that includes a position where a predetermined one out of the plural unexposed regions is surrounded by four exposed regions composed of two first exposed regions that contact the predetermined unexposed region in the radial direction and two second exposed regions that contact the predetermined unexposed region in the direction of rotation and where a second length along the direction of rotation of at least one of the two second exposed regions is shorter than a first length along the direction of rotation of at least one of the two first exposed regions, to control the irradiated position changing unit so that if
a number of times the drawing beam is emitted onto first regions to become the at least one first exposed region is set at N (where N is a natural number that is at least two),
a length along the radial direction of the first regions is set at a third length,
a number of times the drawing beam is emitted onto second regions to become the at least one second exposed region is set at M (where M is a natural number that is at least two), and
a length along the radial direction between a beam center when the drawing beam is emitted onto an innermost periphery in the radial direction of the second regions out of the M times the drawing beam is emitted and a beam center when the drawing beam is emitted onto an outermost periphery in the radial direction of the second regions out of the M times the drawing beam is emitted is set at a fourth length,
a value produced by dividing the fourth length by (M−1) is lower than a value produced by dividing the third length by (N+1).

8. The drawing apparatus according to claim 7,
wherein the control unit is operable when drawing the pattern that includes the position where the predetermined unexposed region is surrounded by the four exposed regions and where the second length of the at least one second exposed regions is shorter than the first length of the at least one first exposed regions, to control the irradiated position changing unit so that a first average irradiation pitch of the drawing beam emitted onto the first regions is narrower than a second average irradiation pitch of the drawing beam emitted onto the second regions.

9. The drawing apparatus according to claim 7,
wherein the control unit is operable when drawing the pattern that includes the position where the predetermined unexposed region is surrounded by the four exposed regions and where the second length of the at least one second exposed regions is shorter than the first length of the at least one first exposed regions, to control the irradiated position changing unit so that a second average irradiation pitch of the drawing beam emitted onto the second regions is narrower than a first average irradiation pitch of the drawing beam emitted onto the first regions.
